(19) United States
(12) Patent Application Publication
(10) Pub. No.: US 2026/0180406 A1
(43) Pub. Date: Jun. 25, 2026

(54) COOLING ASSEMBLIES FOR OUTER ROTOR ELECTRIC MOTORS

(71) Applicant: Donut Lab Development Oü, Harju maakond (EE)

(72) Inventors: Gareth Roberts, Swindon (GB); Joshua Best, Wiltshire (GB); Ville Piippo, Haarajoki (FI)

(21) Appl. No.: 19/000,894

(22) Filed: Dec. 24, 2024

(51) Int. Cl. H02K 9/22; B60K 7/00; B62M 7/12; H02K 9/20

(52) U.S. Cl. CPC H02K 9/227; B60K 7/0007; H02K 9/20; H02K 9/225; B62M 7/12

(57) ABSTRACT

Cooling assemblies for outer rotor electric motors are disclosed. An example electric motor includes a stator, a rotor, and a heat exchanger. The stator has a central axis. The rotor circumscribes the stator. The rotor is configured to rotate relative to the stator. The heat exchanger is coupled to the stator. The stator circumscribes the heat exchanger. The heat exchanger includes a plurality of fins extending in a radially inward direction away from the stator and toward the central axis. In some examples, the fins are circumferentially oriented. In other examples, the fins are axially oriented. In still other examples, the fins are helically oriented.

### FIELD OF THE DISCLOSURE

This disclosure relates generally to electric machines and, more specifically, to cooling assemblies for outer rotor electric motors.

### BACKGROUND

Electric motors typically include a stator and a rotor, with the rotor being configured to rotate relative to the stator. The stator and the rotor can be implemented in either an inner rotor configuration in which the stator circumscribes the rotor, or conversely in an outer rotor configuration in which the rotor circumscribes the stator. Electric motors are widely used across multiple industries (e.g., automotive, medical, household, etc.) and a variety of applications including vehicles, appliances, tools, fans, blowers, turbines, compressors, pumps, etc.

Electric vehicles have risen in popularity over the past decade. Electric vehicles are typically powered by one or more electric motor(s) that draw(s) electricity from an onboard rechargeable battery. Electric vehicles exist in many forms; wheeled electric vehicles, for example, include cars, vans, trucks, motorcycles, scooters, etc. that include at least one wheel powered by an electric motor. The majority of wheeled electric vehicles include powertrains having an inboard electric motor, transmission, and driveline, all of which contribute to the mass, complexity, and losses of the propulsion system, as well as a volume penalty within the chassis of the vehicle. In some implementations of a wheeled electric vehicle, the primary components of the electric motor are integrated into and/or incorporated within the wheel itself. Such implementations are commonly referred to as “in-wheel” electric motors. A key advantage of in-wheel electric motors is the ability to eliminate many if not all of the aforementioned peripheral components and the penalties associated therewith, and also to provide significant improvement in transient performance.

Electric motors typically require a cooling system that prevents the electric motor from overheating during periods of extended and/or continuous use. The peak/continuous torque and power of an electric motor is directly linked to the performance of the coupled cooling system. Cooling systems for in-wheel electric motors of electric vehicles have traditionally been implemented via a liquid-cooled jacket and a radiator operatively coupled thereto, with the liquid-cooled jacket being located at the periphery of the electric motor and the radiator being located elsewhere (e.g., away from the electric motor) within the electric vehicle. Such traditional cooling systems often have a significant mass and/or volume that negatively impacts the torque and/or power performance characteristics associated with the electric motor. Furthermore, using a liquid to transport heat energy from the electric motor to an area of high airflow presents further practical limitations such as packaging, fault tolerance, and maintenance. These practical limitations are of even greater concern when specifically considering in-wheel electric motors, as the complexity of the coolant routing increases, as does the fault probability due to the exposure to suspension loading and a greater required range of movement.

### BRIEF DESCRIPTION OF THE DRAWINGS

FIG. 1 is a side view of an example electric motor having an outer rotor configuration.

FIG. 2 is a block diagram of an example electric vehicle including an in-wheel electric motor.

FIG. 3 is a perspective view of an example implementation of the electric vehicle of FIG. 2.

FIG. 4 is a side view of an example stator.

FIG. 5 is an enlarged view of a portion of FIG. 4.

FIG. 6 is a perspective view of an example edgewise coil.

FIG. 7 is a perspective view of the edgewise coil of FIG. 6 positioned for radial loading onto a tooth of the stator of FIG. 4.

FIG. 8 is a perspective view of a first example heat transfer configuration including a plurality of example radial extrusions.

FIG. 9 is a perspective view of a second example heat transfer configuration including a plurality of example heat pipes.

FIG. 10 is a cross-sectional view of an example end plate that can be incorporated into the second heat transfer configuration of FIG. 9.

FIG. 11 is a cross-sectional view of an example cooling passage that can be incorporated into the end plate of FIG. 10.

FIG. 12 is a perspective view of an example heat exchanger including a plurality of example circumferentially oriented fins.

FIG. 13 is a cross-sectional view of the heat exchanger of FIG. 12 taken along the X-Y plane of FIG. 12.

FIG. 14 is an example temperature distribution diagram for the heat exchanger of FIGS. 12 and 13.

FIG. 15 is a perspective view of an example heat exchanger including a plurality of example axially oriented fins.

FIG. 16 is a cross-sectional view of the heat exchanger of FIG. 15 taken along the X-Y plane of FIG. 15.

FIG. 17 is a cross-sectional view illustrating a first example fin configuration for a heat exchanger including axially oriented fins.

FIG. 18 is an enlarged view of a portion of FIG. 17.

FIG. 19 is a cross-sectional view illustrating a second example fin configuration for a heat exchanger including axially oriented fins.

FIG. 20 is a perspective view of an example heat exchanger including a plurality of example helically oriented fins.

FIG. 21 is a cross-sectional view of the heat exchanger of FIG. 20 taken along the X-Y plane of FIG. 20.

FIG. 22 is an example temperature distribution diagram for the heat exchanger of FIGS. 20 and 21.

FIG. 23 is another example temperature distribution diagram for the heat exchanger of FIGS. 20 and 21.

FIG. 24 is an example fluid motion diagram for the heat exchanger of FIGS. 20 and 21.

FIG. 25 is another example fluid motion diagram for the heat exchanger of FIGS. 20 and 21.

FIG. 26 is a side partial cutaway view of an example electric motor including an example disk configured to increase the fluid velocity across an example heat exchanger of the electric motor.

FIG. 27 is a perspective partial cutaway view of the electric motor of FIG. 26.

FIG. 28 is an example fluid motion diagram for the disk of the electric motor of FIGS. 26 and 27.

FIG. 29 is another example fluid motion diagram for the electric motor of FIGS. 26-28.

FIG. 30 is another example fluid motion diagram for the electric motor of FIGS. 26-29.

FIG. 31 is another example fluid motion diagram for the electric motor of FIGS. 26-30.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

Electric machines are widely used across multiple industries (e.g., automotive, medical, household, etc.) and a variety of applications including vehicles, appliances, tools, fans, blowers, turbines, compressors, pumps, etc. Some example electric motors disclosed herein are configured as in-wheel electric motors for electric vehicles. An in-wheel electric motor is one form of a direct drive electric machine. The disclosed electric motors can alternatively be used in other industries and/or other direct drive electric machine applications that may or may not pertain to electric vehicles, and that may or may not include one or more wheel(s).

As discussed above, electric motors typically require a cooling system that prevents the electric motor from overheating during periods of extended and/or continuous use. The peak/continuous torque and power of an electric motor is directly linked to the performance of the coupled cooling system. Cooling systems for in-wheel electric motors of electric vehicles have traditionally been implemented via a liquid-cooled jacket and a radiator operatively coupled thereto, with the liquid-cooled jacket being located at the periphery of the electric motor and the radiator being located elsewhere (e.g., away from the electric motor) within the electric vehicle. Such traditional cooling systems often have a significant mass and/or volume that negatively impacts the torque and/or power performance characteristics associated with the electric motor. Furthermore, using a liquid to transport heat energy from the electric motor to an area of high airflow presents further practical limitations such as packaging, fault tolerance, and maintenance. These practical limitations are of even greater concern when specifically considering in-wheel electric motors, as the complexity of the coolant routing increases, as does the fault probability due to the exposure to suspension loading and a greater required range of movement.

Outer rotor electric motors disclosed herein include a heat exchanger located radially inward from the stator of the electric motor (e.g., along the inner circumference of the core of the stator), with the heat exchanger being thermally coupled to the stator so as to directly or indirectly transfer heat from the windings of an armature carried by the stator to ambient air that surrounds and/or flows through the heat exchanger. The incorporation of such a heat exchanger advantageously enables the disclosed outer rotor electric motors to produce higher torque and power densities when compared to known outer rotor electric motors having traditional cooling systems that rely on the circulation of a cooling fluid. The incorporation of such a heat exchanger also advantageously enables cooling to occur using the surrounding ambient air as the cooling medium without the need for an additional active cooling system. The complexity of the cooling system is accordingly reduced, which in turn improves the fault tolerance and maintenance requirements associated with the cooling system and/or, more generally, associated with the electric motor.

The effectiveness of a heat exchanger is typically influenced by: (1) fluid flow rate within and/or through the heat exchanger, which is typically defined by aerodynamic features of the electric motor and the cooling system thereof; (2) the surface area of the heat exchanger, which is defined by the heat exchanger geometry (e.g., number, shape, spacing, thickness, radial length, axial length, etc. of fins of the heat exchanger); and (3) heat transfer properties of the heat exchanger material and cooling medium. The heat exchangers disclosed herein include fins that provide a relatively large cooling surface area for an outer rotor electric motor. In some disclosed examples, the shape and/or orientation of the fins of the heat exchanger advantageously increases the airflow velocity within and/or through the heat exchanger, thereby enhancing the heat transfer rate associated with the heat exchanger. In some disclosed examples, a bladed disk that is coupled to a rotor of a disclosed outer rotor electric motor incorporating such a heat exchanger further increases the airflow velocity within and/or through the heat exchanger, thereby further enhancing the heat transfer rate associated with the heat exchanger.

In some disclosed examples, an electric motor includes a stator, a rotor, and a heat exchanger. The stator has a central axis. The rotor circumscribes the stator. The rotor is configured to rotate relative to the stator. The heat exchanger is coupled to the stator. The stator circumscribes the heat exchanger. The heat exchanger includes a plurality of fins extending in a radially inward direction away from the stator and toward the central axis.

In some disclosed examples, respective ones of the plurality of fins are circumferentially oriented. In other disclosed examples, respective ones of the plurality of fins are axially oriented. In still other disclosed examples, respective ones of the plurality of fins are helically oriented.

In some disclosed examples, respective ones of the plurality of fins are spaced apart from the central axis by a uniform distance. In other disclosed examples, the plurality of fins includes first respective ones of the plurality of fins spaced apart from the central axis by a first distance and second respective ones of the plurality of fins spaced apart from the central axis by a second distance different from the first distance.

In some disclosed examples, the electric motor further includes a disk coupled to the rotor. The disk is configured to rotate with the rotor as the rotor rotates relative to the stator. The disk includes an inner surface that covers a side portion of the stator and a side portion of the heat exchanger. The disk further includes a plurality of blades extending in an axially inward direction away from the inner surface and toward the heat exchanger.

In some disclosed examples, the heat exchanger further includes an interface layer located between the stator and the plurality of fins. In some examples, the plurality of fins and the interface layer are formed from the same material. In other examples, the plurality of fins and the interface layer are formed from different materials.

In some disclosed examples, the stator includes a core and further includes a plurality of teeth extending in a radially outward direction away from the core. Respective ones of the plurality of teeth are spaced apart from one another by respective ones of a plurality of slots. The stator further includes a plurality of edgewise coils. Respective ones of the plurality of edgewise coils are radially loaded onto corresponding respective ones of the plurality of the teeth.

In some disclosed examples, the electric motor further includes a plurality of extrusions extending radially between the heat exchanger and the respective ones of the plurality of edgewise coils such that the respective ones of the plurality of edgewise coils are directly thermally coupled to the heat exchanger via respective ones of the plurality of extrusions.

In some disclosed examples, the electric motor further includes a plurality of heat pipes extending axially between the respective ones of the plurality of edgewise coils. The heat exchanger further includes an end plate extending radially between an interface layer of the heat exchanger and the respective ones of the plurality of heat pipes such that the respective ones of the plurality of edgewise coils are directly thermally coupled to the interface layer of the heat exchanger via the end plate and the respective ones of the plurality of heat pipes.

In some disclosed examples, the electric motor is implemented as an in-wheel electric motor configured for use by and/or with an electric vehicle.

The above-identified features as well as other advantageous features of example cooling assemblies for outer rotor electric motors are further described below in connection with the figures of the application.

As used herein, the term “electric machine(s)” encompasses electric motor(s) configured to transform electrical energy into mechanical energy, and further encompasses electric generator(s) configured to transform mechanical energy into electrical energy.

As used herein in a mechanical context, the term “configured” means sized, shaped, arranged, structured, oriented, positioned, and/or located. For example, in the context of a first part configured to fit within a second part, the first part is sized, shaped, arranged, structured, oriented, positioned, and/or located to fit within the second part. As used herein in an electrical and/or computing context, the term “configured” means arranged, structured, and/or programmed. For example, in the context of processor circuitry configured to perform a specified operation, the processor circuitry is arranged, structured, and/or programmed (e.g., based on machine-readable instructions) to perform the specified operation.

As used herein in the context of a first object circumscribing a second object, the term “circumscribe” means that the first object is constructed around and/or defines an area around the second object. In interpreting the term “circumscribe” as used herein, it is to be understood that the first object circumscribing the second object can include gaps and/or can consist of multiple spaced-apart objects, such that a boundary formed by the first object around the second object is not necessarily a continuous boundary.

As used herein, unless otherwise stated, the terms “above” and “below” describe the relationship of two parts relative to Earth. For example, as used herein, a first part is “above” a second part if the second part is closer to Earth than the first part is. As another example, as used herein, a first part is “below” a second part if the first part is closer to Earth than the second part is. It is to be understood that a first part can be above or below a second part with one or more of: another part or parts therebetween; without another part therebetween; with the first and second parts contacting one another; or without the first and second parts contacting one another.

As used herein, connection references (e.g., attached, coupled, mounted, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts at the point (or points) of contact between the two parts.

As used herein, the term “fastener” means any device(s), structure(s), and/or material(s) that is/are configured, individually or collectively, to couple, connect, attach, and/or fasten one or more component(s) to one or more other component(s). For example, a fastener can be implemented by any type(s) and/or any number(s) of bolts, nuts, screws, posts, anchors, rivets, pins, clips, ties, welds, adhesives, etc.

As used herein, the term “in electrical communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, the terms “substantially” and/or “approximately” modify their subjects and/or values to recognize the potential presence of variations that occur in real world applications. For example, “substantially” and/or “approximately” may modify dimensions that may not be exact due to manufacturing tolerances and/or other real-world imperfections as will be understood by persons of ordinary skill in the art. For example, “substantially” and/or “approximately” may indicate such dimensions may be within a tolerance range of +/−10% unless otherwise specified in the description provided herein.

As used herein, the terms “including” and “comprising” (and all forms and tenses thereof) are open-ended terms. Thus, whenever the written description or a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements, or method actions may be implemented by, for example, the same entity or object. Additionally, although individual features may be included in different examples or claims, these may possibly be combined, and the inclusion in different examples or claims does not imply that a combination of features is not feasible and/or advantageous.

The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C.

As used herein, when the phrase “at least” is used as the transition term in, for example, a preamble of a claim, it is open-ended in the same manner as the term “comprising” and “including” are open-ended. As used herein in the context of describing structures, components, items, objects, and/or things, the phrase “at least one of A and B” is intended to refer to implementations including any of (1) at least one A, (2) at least one B, or (3) at least one A and at least one B. Similarly, as used herein in the context of describing structures, components, items, objects, and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, and/or steps, the phrase “at least one of A or B” is intended to refer to implementations including any of (1) at least one A, (2) at least one B, or (3) at least one A and at least one B.

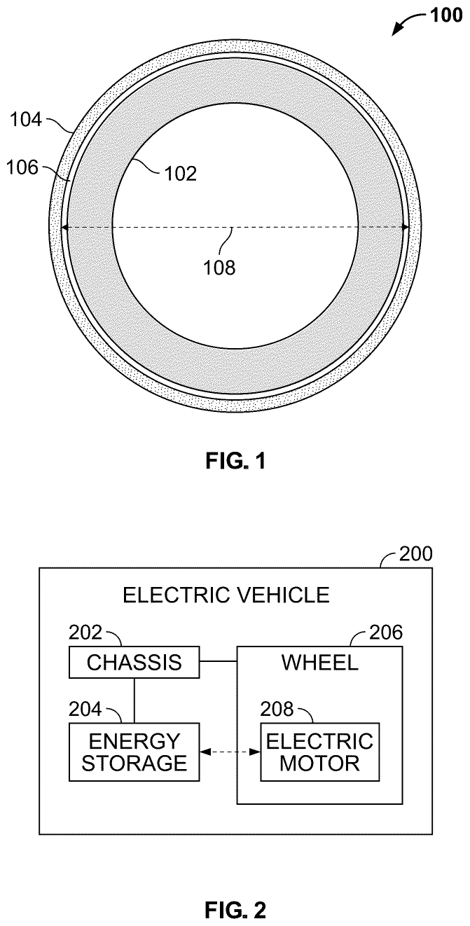

FIG. 1 is a side view of an example electric motor 100 having an outer rotor configuration. The electric motor 100 of FIG. 1 can be implemented in a manner that enables the electric motor 100 to function and/or operate either as an electric motor or as an electric generator. In the illustrated example of FIG. 1, the electric motor 100 includes an example stator 102 and an example rotor 104, with the stator 102 and the rotor 104 being arranged such that the rotor 104 circumscribes the stator 102. The rotor 104 of the electric motor 100 of FIG. 1 is configured to rotate relative to the stator 102. As shown in FIG. 1, the radial thickness of the stator 102 is substantially greater than the radial thickness of the rotor 104. The stator 102 and the rotor 104 are separated by an example air gap 106 having an example diameter 108 that generally corresponds to the inner diameter of the rotor 104. The presence of the air gap 106 facilitates rotation of the rotor 104 relative to the stator 102.

The diameter 108 of the air gap 106 of the electric motor 100 of FIG. 1 is substantially greater than a diameter of an air gap of a similarly-sized (e.g., identically sized) electric motor having an inner rotor configuration. The increased (e.g., maximized) diameter 108 of the air gap 106 associated with the outer rotor configuration of the electric motor 100 of FIG. 1 advantageously increases the volumetric torque density associated with the electric motor 100 relative to that of a similarly-sized electric motor having an inner rotor configuration. As a result, the outer rotor electric motor 100 of FIG. 1 is advantageously able to produce more torque in the package space (e.g., the overall volume of the motor) of the electric motor 100 in comparison to the torque which might be produced in the similarly-sized (e.g., identically-sized) package space (e.g., the overall volume of the motor) of an inner rotor electric motor. Outer rotor electric motors of the type shown in association with the electric motor 100 of FIG. 1 can accordingly be beneficial for applications requiring the generation of high levels of torque.

FIG. 2 is a block diagram of an example electric vehicle 200 including an in-wheel electric motor. While the electric vehicle 200 of FIG. 2 is illustrated as having a single in-wheel electric motor associated with a single electrically-driven wheel, it is to be understood that the electric vehicle 200 can alternatively include a different number (e.g., two, three, four, etc.) of in-wheel electric motors associated with a different number (e.g., two, three, four, etc.) of electrically-driven wheels. It is also to be understood that the electric vehicle 200 of FIG. 2 can include one or more wheel(s) that is/are not electrically driven in addition to the one or more electrically-driven wheel(s) that is/are associated with the in-wheel electric motor(s) of the electric vehicle 200. For example, when the electric vehicle 200 of FIG. 2 is implemented as a two-wheeled electric motorcycle, the electric vehicle 200 may include a rear wheel that incorporates an in-wheel electric motor, and a front wheel that does not incorporate an in-wheel electric motor. As another example, when the electric vehicle 200 of FIG. 2 is implemented as a four-wheeled electric automobile, the electric vehicle 200 may include two rear wheels, with each of the rear wheels incorporating an in-wheel electric motor, and two front wheels, with neither of the front wheels incorporating an in-wheel electric motor. Aside from requiring at least one in-wheel electric motor (i.e., one electric motor incorporated into one wheel), the electric vehicle 200 of FIG. 2 is not otherwise limited to any particular combination and/or configuration with regard to the number(s), type(s), and/or arrangement(s) of the electric motor(s), the wheel(s), and/or any other component(s) that may form part of the electric vehicle 200.

In the illustrated example of FIG. 2, the electric vehicle 200 includes an example chassis 202, an example energy storage 204, an example wheel 206, and an example electric motor 208. The chassis 202 of FIG. 2 is a structural framework configured to support and/or carry one or more other structural component(s) of the electric vehicle 200. For example, the chassis 202 can be implemented as a frame configured to carry and/or support the energy storage 204 and/or the wheel 206 of the electric vehicle 200. The specific size, shape, and/or configuration of the chassis 202 will vary depending upon the intended application. For example, the chassis 202 may have a first configuration when the electric vehicle 200 of FIG. 2 is implemented as a two-wheeled electric motorcycle, and a second, different configuration when the electric vehicle 200 is implemented as a four-wheeled electric automobile. The energy storage 204 of FIG. 2 is mechanically coupled to (e.g., supported and/or carried by) the chassis 202 of the electric vehicle 200 and operatively coupled to (e.g., in electrical communication with) the electric motor 208 of the electric vehicle 200. The energy storage 204 is configured to transfer energy to the electric motor 208, and/or to receive energy from the electric motor 208. For example, when the electric motor 208 is implemented in a manner that enables the electric motor 208 to function and/or operate either as an electric motor or as an electric generator, the energy storage 204 can either transfer electrical energy to the electric motor 208, which thereafter converts the electrical energy into mechanical energy, or the electric motor 208 can convert mechanical energy into electrical energy, and thereafter transfer the electrical energy to the energy storage 204. The energy storage 204 of FIG. 2 can be implemented as either a DC power source with an inverter to convert DC power to AC power, or as an AC power source.

The wheel 206 of FIG. 2 is mechanically coupled to (e.g., supported and/or carried by) the chassis 202 of the electric vehicle 200. The specific size, shape, and/or configuration of the wheel 206 will vary depending upon the intended application. For example, the wheel 206 may have a first configuration when the electric vehicle 200 of FIG. 2 is implemented as a two-wheeled electric motorcycle, and a second, different configuration when the electric vehicle 200 is implemented as a four-wheeled electric automobile. In the illustrated example of FIG. 2, the wheel 206 incorporates and/or otherwise includes the electric motor 208 such that the electric motor 208 constitutes an in-wheel electric motor. The electric motor 208 of FIG. 2 is mechanically coupled to (e.g., supported and/or carried by) the chassis 202 of the electric vehicle 200. The specific size, shape, and/or configuration of the electric motor 208 will vary depending upon the intended application. For example, the electric motor 208 may have a first configuration when the electric vehicle 200 of FIG. 2 is implemented as a two-wheeled electric motorcycle, and a second, different configuration when the electric vehicle 200 is implemented as a four-wheeled electric automobile. In the illustrated example of FIG. 2, the electric motor 208 is preferably implemented by and/or as an electric motor having an outer rotor configuration (e.g., the electric motor 100 of FIG. 1 described above) in which a rotor of the electric motor 208 circumscribes a stator of the electric motor 208, with the rotor being configured to rotate relative to the stator. In such an implementation, the wheel 206 includes a tire that circumscribes and is mechanically coupled to the rotor of the electric motor 208 such that rotation of the rotor causes a corresponding rotation of the tire.

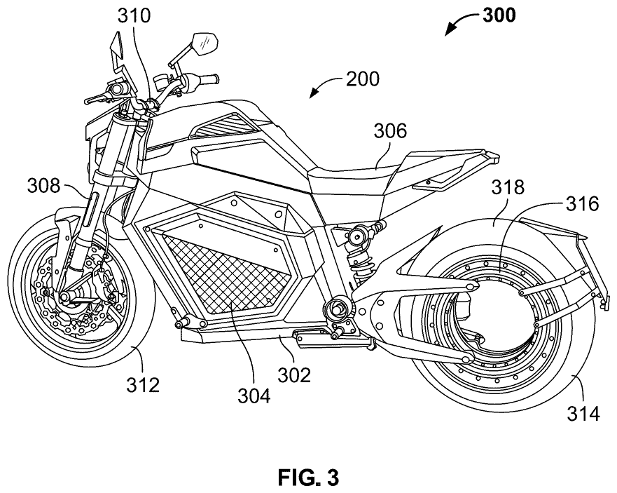

FIG. 3 is a perspective view of an example implementation of the electric vehicle 200 of FIG. 2. As shown in FIG. 3, the electric vehicle 200 is implemented as an electric motorcycle 300. An example chassis 302 of the electric motorcycle 300 (e.g., corresponding to the chassis 202 of FIG. 2) is configured to support and/or carry numerous structural component(s) of the electric motorcycle 300. For example, as shown in FIG. 3, the chassis 302 supports and/or carries an energy storage (e.g., a battery) that is concealed and/or otherwise located behind and/or within an example protective housing 304 associated with the chassis 302. The chassis 302 further supports and/or carries an example seat 306 of the electric motorcycle 300. The chassis 302 further supports and/or carries example forks 308 that support and/or carry example handlebars 310 and/or an example front wheel 312 of the electric motorcycle 300. The chassis 302 further supports and/or carries an example rear wheel 314 (e.g., corresponding to the wheel 206 of FIG. 2) that includes an example electric motor 316 (e.g., corresponding to the electric motor 208 of FIG. 2) of the electric motorcycle 300. The rear wheel 314 of the electric motorcycle 300 of FIG. 3 accordingly includes an in-wheel electric motor, while the front wheel 312 of the electric motorcycle 300 of FIG. 3 lacks any such in-wheel electric motor.

In the illustrated example of FIG. 3, the electric motor 316 is implemented in a manner that enables the electric motor 316 to function and/or operate either as an electric motor or as an electric generator. The electric motor 316 of the electric motorcycle 300 of FIG. 3 has an outer rotor configuration in which a rotor of the electric motor 316 circumscribes a stator of the electric motor 316, with the rotor being configured to rotate relative to the stator. The rear wheel 314 of the electric motorcycle 300 includes an example tire 318 that circumscribes and is mechanically coupled to the rotor of the electric motor 316 such that rotation of the rotor causes a corresponding rotation of the tire 318. The electric motorcycle 300 of FIG. 3 illustrates one of many possible example implementations of the electric vehicle 200 of FIG. 2. As discussed above, numerous other example implementations of the electric vehicle 200 of FIG. 2 are possible, are contemplated, and/or are within the scope of the inventions disclosed herein.

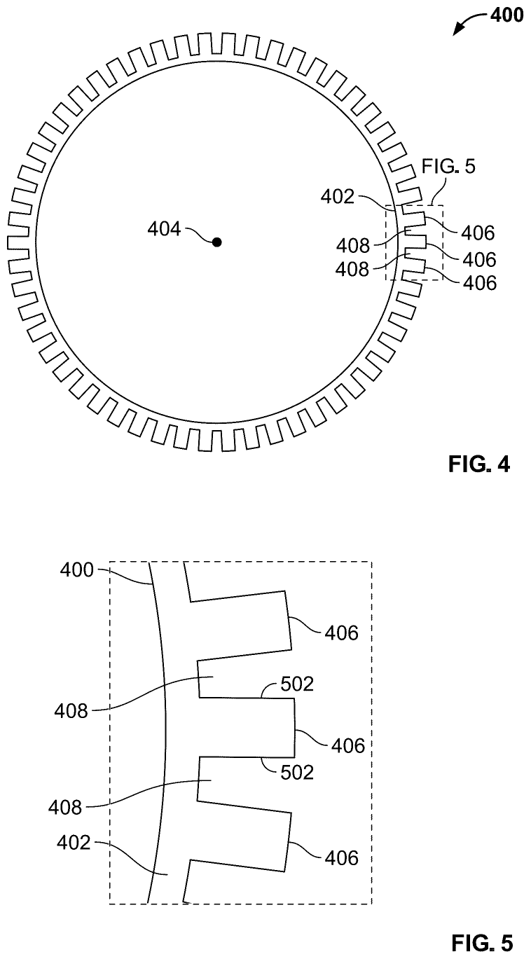

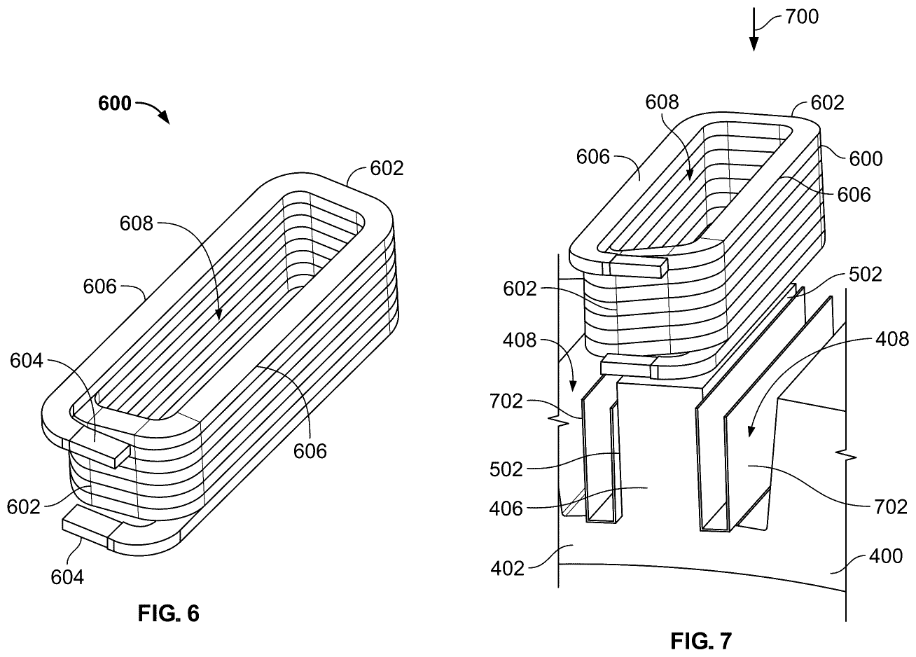

FIG. 4 is a side view of an example stator 400. FIG. 5 is an enlarged view of a portion of FIG. 4. The stator 400 of FIGS. 4 and 5 is configured to be incorporated into and/or otherwise included in an electric machine (e.g., an electric motor) having an outer rotor configuration. The stator 400 of FIGS. 4 and 5 can accordingly be incorporated into and/or otherwise included in an in-wheel electric motor of an electric vehicle (e.g., the electric motor 208 of the wheel 206 of the electric vehicle 200 of FIG. 3, the electric motor 316 of the rear wheel 314 of the electric motorcycle 300 of FIG. 3, etc.). The stator 400 of FIGS. 4 and 5 can alternatively be incorporated into and/or otherwise included in other types of outer rotor electric machine applications, many of which may be intended for use with devices and/or systems other than electric vehicles (e.g., appliances, tools, assembly lines, etc.).

In the illustrated example of FIGS. 4 and 5, the stator 400 includes an example annular (e.g., ring-shaped) core 402 (e.g., a ferromagnetic core) having an associated central axis 404 that extends in an axial direction. The stator 400 of FIGS. 4 and 5 further includes a plurality of example teeth 406 coupled to and circumferentially arranged about the outside of the core 402. In this regard, each tooth 406 of the stator 400 extends from the core 402 in a radially outward direction, with respective ones (e.g., neighboring ones) of the plurality of teeth 406 being spaced apart from one another by a corresponding plurality of example slots 408. As shown in FIGS. 4 and 5, each tooth 406 of the stator 400 has a rectangular cross-sectional shape defined in part by a pair of example parallel walls 502 that extend in an axial direction. The parallel walls 502 of each tooth 406 form a pair of opposed, axially-extending, parallel surfaces onto which a winding (e.g., a pre-formed edgewise coil) is to be radially loaded, as further described herein.

Windings (e.g., coils) can be added around the teeth 406 and/or within the slots 408 of the stator 400 of FIGS. 4 and 5 to form an armature of the stator 400. In some examples, the windings can be formed from wire having a generally circular (e.g., round) cross-sectional area. In other examples, the windings can instead be formed from wire having a rectangular cross-sectional area. In some examples utilizing a rectangular wire construction, a hairpin architecture is used. In other examples utilizing a rectangular wire construction, the rectangular wire is bent and/or wound along the short side (e.g., as opposed to the long side) of the rectangular cross-sectional area of the wire. This winding approach is commonly referred to as edgewise winding, with the resultant winding and/or coil of wire being referred to as an edgewise coil.

FIG. 6 is a perspective view of an example edgewise coil 600. In the illustrated example of FIG. 6, the edgewise coil 600 includes two example end winding regions 602, two example connection points 604, and two example torque-generating regions 606. The edgewise coil 600 further includes an example opening 608 extending centrally through the edgewise coil 600. The edgewise coil 600 of FIG. 6 is formed by pre-winding rectangular wire along the short side (e.g., as opposed to the long side) of the rectangular cross-sectional area of the wire into the coiled shape and/or coiled configuration shown in FIG. 6, which then enables the formed, pre-wound rectangular wire that constitutes the edgewise coil 600 to be radially loaded onto a tooth of a stator (e.g., one of the teeth 406 of the stator 400 of FIG. 4) and/or into a slot of a stator (e.g., one of the slots 408 of the stator 400 of FIG. 4), as further described herein. In the illustrated example of FIG. 6, the edgewise coil 600 includes eight layers, commonly known as turns, of wound and/or coiled rectangular wire. In other examples, the edgewise coil 600 can instead include a different number (e.g., four, six, ten, twelve, etc.) of layers of wound and/or coiled rectangular wire. The edgewise coil 600 of FIG. 6 is advantageous over other winding approaches and/or other wire types in that the turns of the edgewise coil 600 do not need to be welded, and the end winding regions 602 of the edgewise coil 600 are very compact.

FIG. 7 is a perspective view of the edgewise coil 600 of FIG. 6 positioned for radial loading onto a tooth 406 of the stator 400 of FIG. 4. As shown in FIG. 7, a tooth 406 of the stator 400 has a rectangular cross-sectional shape defined in part by a pair of parallel walls 502 that extend in an axial direction. The parallel walls 502 of the tooth 406 form a pair of opposed, axially-extending, parallel surfaces that facilitate loading the edgewise coil 600 in an example radial direction 700 onto the tooth 406 of the stator 400. As shown in FIG. 7, the opening 608 formed in the edgewise coil 600 has a size and shape that complements the rectangular cross-sectional shape of the tooth 406 of the stator 400 such that the parallel walls 502 of the tooth 406 guide the edgewise coil 600 onto the tooth 406 as the edgewise coil 600 is moved in the radial direction 700 onto the tooth 406 and toward the core 402 of the stator 400. As the edgewise coil 600 is radially loaded onto the tooth 406, one of the two torque-generating regions 606 of the edgewise coil 600 is received within a first one of the slots 408 of the stator 400 located adjacent a first one of the parallel walls 502 of the tooth 406, and the other one of the two torque-generating regions 606 of the edgewise coil 600 is received within a second one of the slots 408 of the stator 400 located adjacent a second one of the parallel walls 502 of the tooth 406. Upon being radially loaded onto the tooth 406 of the stator 400, the edgewise coil 600 thereafter circumscribes the tooth 406 of the stator 400.

In some examples, one or more layer(s) of insulation are located and/or positioned between the tooth 406 of the stator 400 and the edgewise coil 600 prior to and/or in conjunction with radially loading the edgewise coil 600 onto the tooth 406. The insulation can take many forms (e.g., wire enamel, potting, slot liners, etc.), but is preferably implemented as a plurality of slot liners. In some examples, the insulation can be coupled and/or otherwise applied to (e.g., inserted into) the slots 408 bordering the tooth 406 of the stator 400 prior to the edgewise coil 600 being radially loaded onto the tooth 406. For example, as shown in FIG. 7, a pair of example slot liners 702 are applied (e.g., radially, or axially applied) to corresponding ones of the slots 408 bordering the tooth 406 of the stator 400 prior to the edgewise coil 600 being radially loaded onto the tooth 406. In such an example, the slot liners 702 will receive corresponding ones of the torque-generating regions 606 of the edgewise coil 600 concurrently with the edgewise coil 600 being radially loaded onto the tooth 406 of the stator 400. In other examples, the insulation can instead be coupled and/or otherwise applied to (e.g., at least partially wrapped around) the edgewise coil 600 prior to the edgewise coil 600 being radially loaded onto the tooth 406 of the stator 400. In each of the foregoing examples, radially loading the edgewise coil 600 onto the tooth 406 of the stator 400 results in the slot liners 702 being located and/or positioned between the edgewise coil 600 and tooth 406.

In some examples, the process of loading the edgewise coil 600 in the radial direction 700 onto the tooth 406 of the stator 400 is performed manually (e.g., by a human). In other examples, the process of loading the edgewise coil 600 in the radial direction 700 onto the tooth 406 of the stator 400 can instead be assisted by a machine (e.g., a robotic assist). In still other examples, the process of loading the edgewise coil 600 in the radial direction 700 onto the tooth 406 of the stator 400 can instead be fully automated, and/or can be performed without human interaction and/or guidance. While the example of FIG. 7 describes the process of radially loading a single edgewise coil 600 onto a single tooth 406 of the stator 400, it is to be understood that additional instances of the edgewise coil 600 can be radially loaded onto additional ones of the teeth 406 of the stator 400 in a manner that is substantially identical to that described above.

In some implementations, the end winding regions of the windings of the armature of the electric motor (e.g., the end winding regions 602 of a plurality of edgewise coils 600) are not closely thermally coupled to either the core 402 or to teeth 406 of the stator 400. The end winding regions are therefore typically of a higher local temperature, which accordingly limits the performance of the electric motor. To combat this disadvantage, in some examples the end winding regions of the windings (e.g., coils) of the armature of the electric motor (e.g., the end winding regions 602 of a plurality of edgewise coils 600) can be coupled directly to a heat exchanger of the electric motor via a suitable structural geometry, as further described herein.

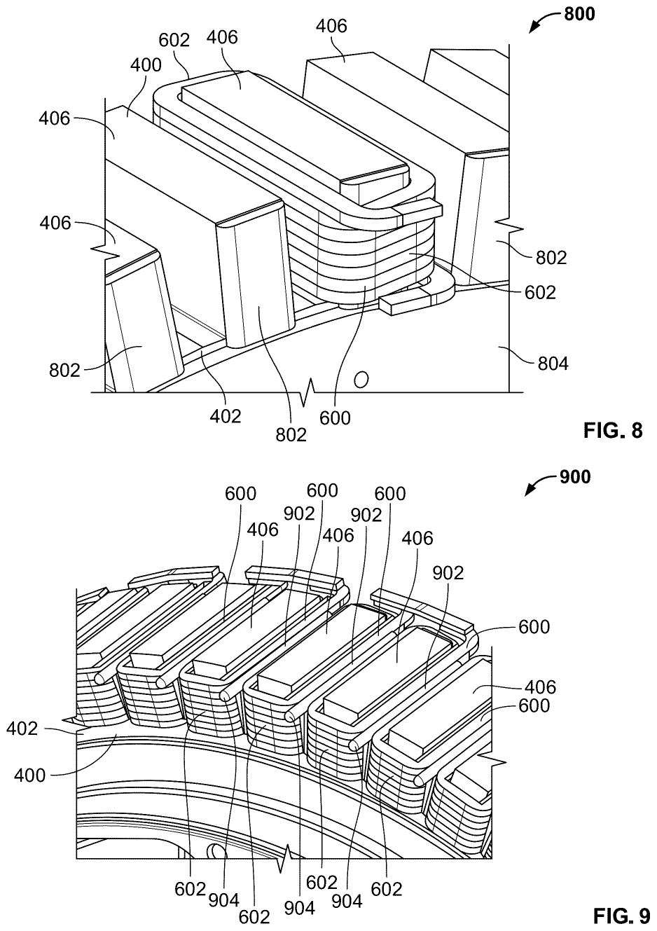

For example, FIG. 8 is a perspective view of a first example heat transfer configuration 800 including a plurality of example radial extrusions 802. In the illustrated example of FIG. 8, each one of the radial extrusions 802 is coupled to and/or otherwise located along (e.g., adjacent to) a side surface of a corresponding one of the teeth 406 of the stator 400. Each one of the radial extrusions 802 extends in a radially inward direction from the corresponding one of the teeth 406, past the core 402 of the stator 400, and to an example heat exchanger 804 to which the core 402 of the stator 400 is coupled.

Each one of the radial extrusions 802 is configured to be in direct contact with at least a portion of the end windings of the armature of the stator 400. For example, as shown in FIG. 8, one of the end winding regions 602 of the edgewise coil 600 of FIGS. 6 and 7 described above directly contacts a corresponding one of the radial extrusions 802 such that the corresponding end winding region 602 of the edgewise coil 600 is thermally coupled to the heat exchanger 804 via the corresponding one of the radial extrusions 802. As a result of the thermal coupling formed by the corresponding one of the radial extrusions 802, heat generated and/or carried by the corresponding end winding region 602 of the edgewise coil 600 is transferred to the heat exchanger 804 directly through the corresponding one of the radial extrusions 802.

In other examples, the radial extrusions 802 shown in FIG. 8 can be implemented in connection with a type of winding other than the edgewise coil 600 shown in FIG. 8. For example, the radial extrusions 802 of FIG. 8 can instead be implemented in connection with wire having a rectangular cross-sectional area that is wound into a coil structure other than an edgewise coil. As another example, the radial extrusions 802 of FIG. 8 can instead be implemented in connection with wire having a generally circular (e.g., round) cross-sectional area that is wound into a coil.

The radial extrusions 802 of FIG. 8 advantageously reduce the temperature of the end winding regions of the windings (e.g., the end winding regions 602 of the edgewise coils 600), thereby allowing a higher current to be used in the windings before the same temperature limit in the windings is achieved. Furthermore, directly reducing the hotspots in the windings advantageously lowers the thermal fatigue on the winding insulations, thereby promoting the longevity of the electric motor as a whole.

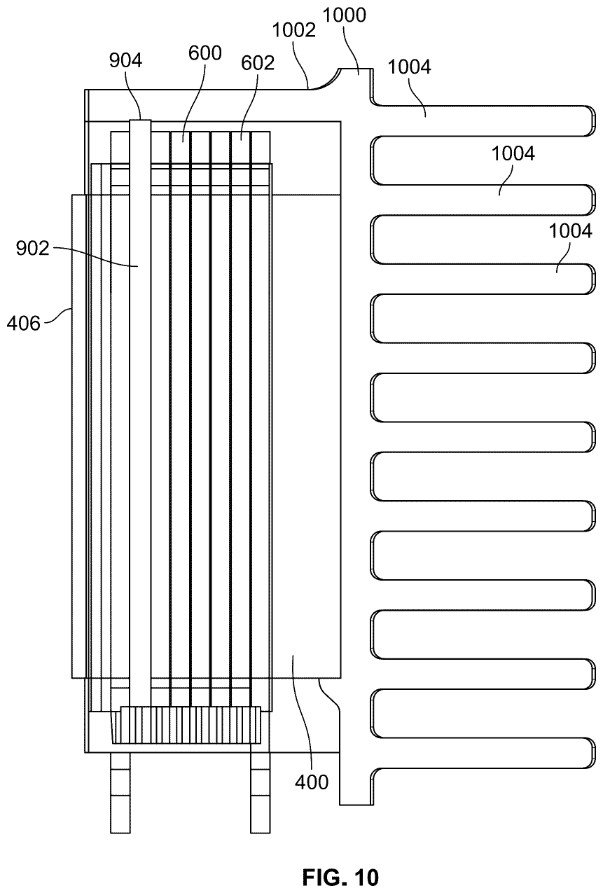

As another example of a structural geometry that promotes a more efficient transfer of heat, FIG. 9 is a perspective view of a second example heat transfer configuration 900 including a plurality of example heat pipes 902. In the illustrated example of FIG. 9, each one of the heat pipes 902 is positioned between two neighboring teeth 406 of the stator 400 and, more specifically, between two neighboring windings (e.g., two neighboring coils) located on such neighboring teeth 406 of the stator 400 such that the heat pipe 902 is directly thermally coupled thereto. For example, as shown in FIG. 9, each one of the heat pipes 902 is positioned between two neighboring ones of a plurality of edgewise coils that are coupled to corresponding ones of the teeth 406 of the stator 400, with each one of the edgewise coils being implemented by and/or as the edgewise coil 600 of FIGS. 6 and 7 described above. As shown in FIG. 9, each one of the heat pipes 902 extends to and/or beyond at least one of the end winding regions 602 of each one of the two neighboring edgewise coils 600 between which the heat pipe 902 is positioned.

Each one of the heat pipes 902 of FIG. 9 further extends in an axial direction away from (e.g., beyond) the two neighboring windings between which the heat pipe 902 is positioned. For example, as shown in FIG. 9, each one of the heat pipes 902 extends in an axial direction away from (e.g., beyond) the two neighboring edgewise coils 600 between which the heat pipe 902 is positioned, with each one of the heat pipes 902 terminating in an example end portion 904. Axially extending the end portion 904 of each one of the heat pipes 902 in this manner (e.g., as shown in FIG. 9) facilitates a transfer of heat generated and/or carried by the two neighboring windings to a structural portion of a heat exchanger, as further described herein.

In other examples, the heat pipes 902 shown in FIG. 9 can be implemented in connection with a type of winding other than the edgewise coil 600 shown in FIG. 9. For example, the heat pipes 902 of FIG. 9 can instead be implemented in connection with wire having a rectangular cross-sectional area that is wound into a coil structure other than an edgewise coil. As another example, the radial extrusions 802 of FIG. 8 can instead be implemented in connection with wire having a generally circular (e.g., round) cross-sectional area that is wound into a coil.

FIG. 10 is a cross-sectional view of an example end plate 1002 that can be incorporated into the second heat transfer configuration 900 of FIG. 9. In the illustrated example of FIG. 10, the end plate 1002 is coupled to (e.g., integrally formed with) an example heat exchanger 1000 that includes a plurality of example fins 1004, with respective ones of the fins 1004 extending in a radially inward direction away from the stator 400. The end plate 1002 of FIG. 10 is configured such that the end portion 904 of each one of the heat pipes 902 of FIG. 9 described above directly contacts the end plate 1002, thereby thermally coupling the windings (e.g., the edgewise coils 600) of the stator 400 to the heat exchanger 1000. As a result of the thermal coupling formed by the heat pipes 902 and the end plate 1002, heat generated and/or carried by the edgewise coils 600 (e.g., including the end winding regions 602 thereof) is transferred to the heat exchanger 1000 directly through the heat pipes 902 and the end plate 1002.

The heat pipes 902 of FIG. 9 and the end plate 1002 of FIG. 10 advantageously reduce the temperature of the end winding regions of the windings (e.g., the end winding regions 602 of the edgewise coils 600), thereby allowing a higher current to be used in the windings before the same temperature limit in the windings is achieved. Furthermore, directly reducing the hotspots in the windings advantageously lowers the thermal fatigue on the winding insulations, thereby promoting the longevity of the electric motor as a whole.

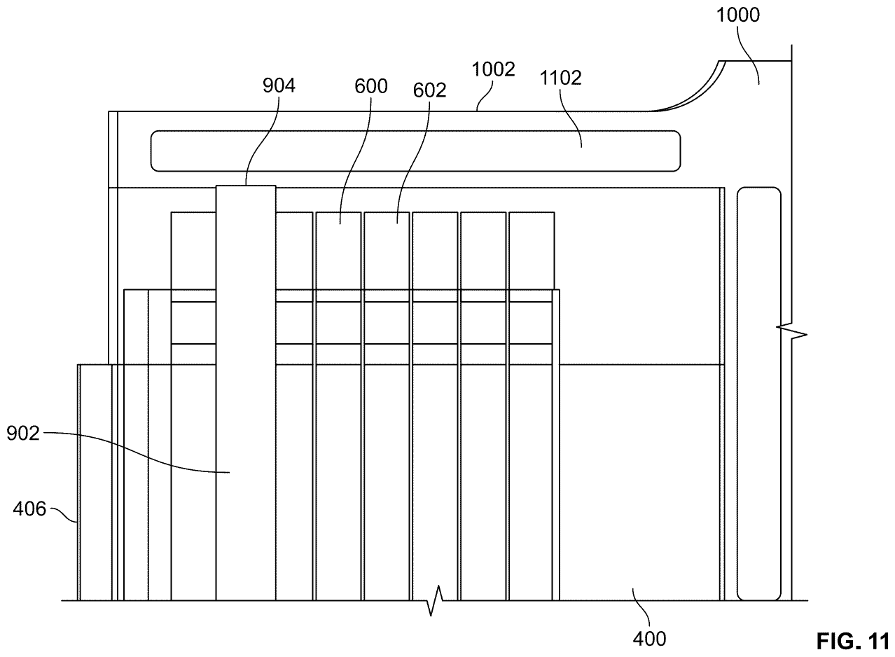

The heat transfer benefits afforded by the end plate 1002 of FIG. 10 described above can be further enhanced via the incorporation of one or more fluid-based (e.g., water-based) cooling passages into the end plate 1002. For example, FIG. 11 is a cross-sectional view showing an example cooling passage 1102 incorporated into the end plate 1002 of FIG. 10. The presence and/or circulation of fluid (e.g., water) within the cooling passage 1102 advantageously reduces the temperature of the surrounding portion of the end plate 1002. As a result of the decreased temperature of the end plate 1002 facilitated via the cooling passage 1102, the end plate 1002 can more efficiently transfer heat received at the end plate 1002 from the heat pipes 902 (e.g., with such heat pipes 902 having received such heat from the edgewise coils 600) to the heat exchanger 1000.

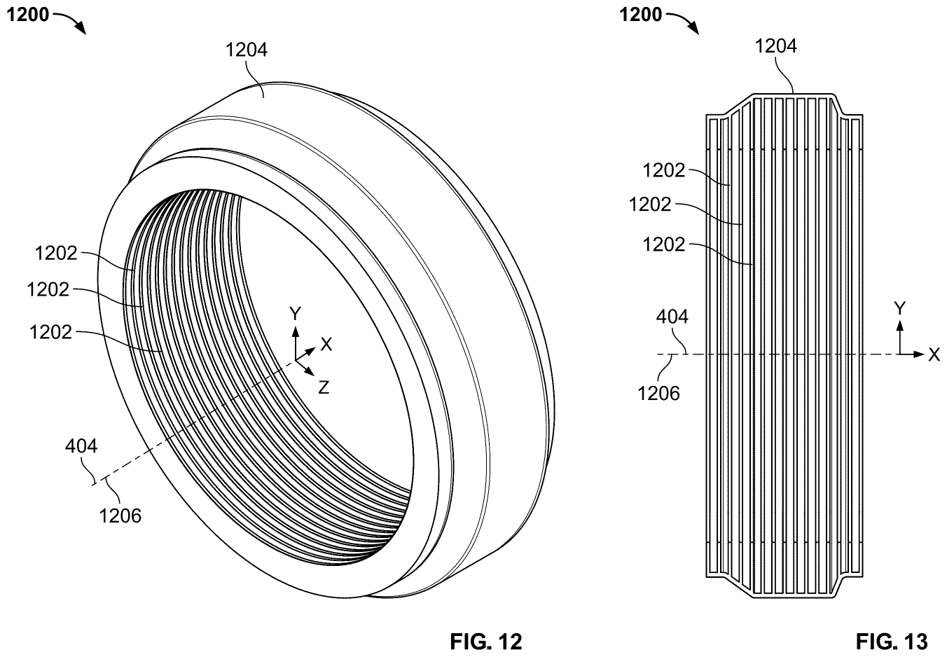

FIG. 12 is a perspective view of an example heat exchanger 1200 including a plurality of example circumferentially oriented fins 1202. FIG. 13 is a cross-sectional view of the heat exchanger 1200 of FIG. 12 taken along the X-Y plane of FIG. 12. The heat exchanger 1200 of FIGS. 12 and 13 is generally an annular-shaped (e.g., ring-shaped) structure that is configured to be coupled to and circumscribed by a stator of an electric motor (e.g., the stator 400 of FIGS. 4 and 5).

In the illustrated example of FIGS. 12 and 13, the heat exchanger 1200 includes an example interface layer 1204 that forms an outer surface of the heat exchanger 1200. The interface layer 1204 can be of any thickness, and can be configured to have any number and/or type of segments, contours, bends, etc., including those shown in FIGS. 12 and 13. The interface layer 1204 of the heat exchanger 1200 is configured to be coupled to (e.g., thermally coupled to) the surrounding stator (e.g., the core 402 of the stator 400 of FIGS. 4 and 5). For example, the interface layer 1204 can be placed in direct physical contact with the core 402 of the surrounding stator 400 such that heat carried by the core 402 is efficiently transferred from the stator 400 to the heat exchanger 1200. In some examples, the radial extrusions 802 of FIG. 8 described above can extend to and/or otherwise contact the interface layer 1204 of the heat exchanger 1200. In other examples, the end plate 1002 of FIGS. 10 and 11 described above (which receives heat from the heat pipes 902 of FIG. 9 described above) can extend to and/or otherwise contact the interface layer 1204 of the heat exchanger 1200.

The interface layer 1204 of FIGS. 12 and 13 can be formed from any material that is suitable for transferring heat. For example, the interface layer 1204 can be formed from aluminum, steel, copper, brass, or some other highly conductive material. In some examples, the interface layer 1204 is formed from the same material as the fins 1202 of the heat exchanger 1200. For example, the fins 1202 and the interface layer 1204 of the heat exchanger 1200 can commonly be formed from aluminum. In other examples, the interface layer 1204 can instead be formed from a different material than the fins 1202 of the heat exchanger 1200. For example, the fins 1202 of the heat exchanger 1200 can be formed from aluminum, and the interface layer 1204 of the heat exchanger 1200 can be formed from copper, brass, or steel.

The heat exchanger 1200 of FIGS. 12 and 13 has an associated central axis 1206 (e.g., the X-axis as shown in FIGS. 12 and 13) that is coaxially located with the central axis 404 of the surrounding stator 400, with the central axis 1206 extending in an axial direction of the annular-shaped heat exchanger 1200. As shown in FIGS. 12 and 13, respective ones of the fins 1202 of the heat exchanger 1200 extend in a radially inward direction away from the interface layer 1204 of the heat exchanger 1200 and toward the central axis 1206 of the heat exchanger 1200. When the heat exchanger 1200 is coupled to the stator 400, the respective ones of the fins 1202 of the heat exchanger 1200 likewise extend in a radially inward direction away from the core 402 of the stator 400 and toward the central axis 404 of the stator 400.

Respective ones of the fins 1202 of FIGS. 12 and 13 are parallel to and are spaced apart from one another, with each one of the fins 1202 being circumferentially oriented relative to the interface layer 1204 of the heat exchanger 1200. When the heat exchanger 1200 is coupled to the stator 400, each one of the fins 1202 of the heat exchanger 1200 is likewise circumferentially oriented relative to the core 402 of the stator 400. When oriented circumferentially as shown in FIGS. 12 and 13, each one of the fins 1202 (e.g., an inner edge of each fin 1202) of the heat exchanger 1200 is oriented perpendicular relative to the central axis 1206 of the heat exchanger 1200 and/or perpendicular relative to the central axis 404 of the stator 400.

In the illustrated example of FIGS. 12 and 13, the heat exchanger 1200 includes approximately fifteen (15) circumferentially oriented fins 1202. In other examples, the heat exchanger 1200 can instead include a greater number or a lesser number of circumferentially oriented fins 1202 relative to the implementation shown in FIGS. 12 and 13. In some examples, one or more (e.g., in some cases all) of the fins 1202 of the heat exchanger 1200 are integrally formed with the interface layer 1204 of the heat exchanger 1200. In other examples, one or more (e.g., in some cases all) of the fins 1202 of the heat exchanger 1200 can be coupled to the interface layer 1204 of the heat exchanger 1200 via one or more fastener(s).

The circumferentially oriented fins 1202 of the heat exchanger 1200 of FIGS. 12 and 13 are preferably spaced apart from one another by a distance of approximately five millimeters (5 mm) or more. In other examples, the circumferentially oriented fins 1202 of the heat exchanger 1200 of FIGS. 12 and 13 can instead be spaced apart from one another by a distance of less than five millimeters (5 mm), although such spacing may result in diminishing returns in the applicable heat transfer coefficient. Similarly, fins having radial lengths greater than five to ten percent (5-10%) of the inner diameter of the heatsink area (e.g., the inner diameter of the interface layer 1204) also exhibit the same diminishing returns. While it may be beneficial for the fins 1202 to be as thin as possible (e.g., minimized thickness) so as to maximize the surface area associated with the plurality of fins 1202 as a whole, the practical limit to this is the required strength of the fins 1202. Each one of the fins 1202 of the heat exchanger 1200 accordingly has a thicknesses that is preferably between two to five millimeters (2-5 mm). This preferred thickness of the fins 1202 enables the fins 1202 to bear structural load resisting compressive loads, as may be encountered when the heat exchanger 1200 is incorporated into an in-wheel outer rotor electric motor of an electric vehicle (e.g., the electric motor 316 of the electric motorcycle of FIG. 3).

In the illustrated example of FIGS. 12 and 13, each one of the fins 1202 of the heat exchanger 1200 is spaced apart from the central axis 1206 of the heat exchanger 1200 and/or the central axis 404 of the stator 400 by a uniform distance. In other examples, one or more first one(s) of the fins 1202 of the heat exchanger 1200 can be spaced apart from the central axis 1206 of the heat exchanger 1200 and/or the central axis 404 of the stator 400 by a first distance, and one or more second one(s) of the fins 1202 of the heat exchanger 1200 can be spaced apart from the central axis 1206 of the heat exchanger 1200 and/or the central axis 404 of the stator 400 by a second distance that differs from (e.g., is greater than or less than) the first distance.

The heat exchanger 1200 of FIGS. 12 and 13 is particularly suitable for incorporation into and/or inclusion within an in-wheel outer rotor electric motor of an electric vehicle. For example, the heat exchanger 1200 can be implemented in connection with the in-wheel outer rotor electric motor 316 located in the rear wheel 314 of the electric motorcycle 300 of FIG. 3. In such an implementation, the rotor of the electric motor 316 circumscribes the stator of the electric motor 316, and the stator of the electric motor 316 circumscribes the heat exchanger 1200 of the electric motor 316, with the rotor being configured to rotate relative to the stator and relative to the heat exchanger 1200.

In view of the electric motor 316 being located in the rear wheel 314 of the electric motorcycle 300 and given the general nature of the aerodynamics of any motorcycle, the fluid flow is turbulent and unpredictable around the heat exchanger 1200 of the electric motor 316. The chosen fin geometry of the heat exchanger 1200 is therefore preferably a geometry that best suits natural convection. From among various fin geometries (e.g., circumferentially oriented, axially oriented, helically oriented) disclosed herein, the circumferentially oriented fin geometry associated with the heat exchanger 1200 of FIGS. 12 and 13 obtains the highest heat transfer coefficient when there is no or very little axial fluid mass flow through the center region of an electric motor incorporating the heat exchanger 1200. This geometry also promotes rotating fluid regions parallel to the central axis 1206 of the heat exchanger 1200 and/or the central axis 404 of the stator 400, which draws the heat to the center of the heat exchanger 1200 and/or to the center of the electric motor to then be evacuated by the free stream of air traveling parallel to the direction of travel of the electric vehicle.

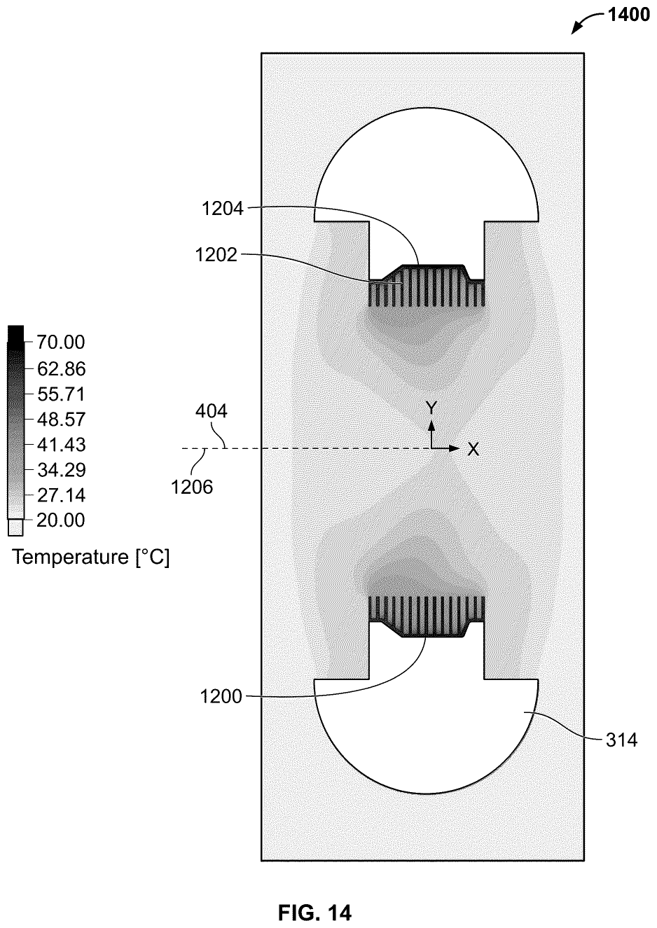

FIG. 14 is an example temperature distribution diagram 1400 for the heat exchanger 1200 of FIGS. 12 and 13. The temperature distribution diagram 1400 of FIG. 14 provides example temperature distribution data associated with implementing the circumferentially oriented fins 1202 of the heat exchanger 1200 according to the preferred dimensions referenced above (e.g., fin spacing of 5 mm or more, fin thickness between 2-5mm, and fin radial length of no more than 5-10% of the inner diameter of the interface layer 1204), and without any axial fluid motion traveling through the center region of the heat exchanger 1200 and/or through the center region of an in-wheel outer rotor electric motor that includes the heat exchanger 1200. Heat transfer coefficient values associated with the circumferentially oriented fin geometry shown in the temperature distribution diagram 1400 of FIG. 14 are comparatively greater than corresponding heat transfer coefficient values associated with other fin geometries (e.g., axially oriented, helically oriented) disclosed herein when there is no axial fluid motion traveling through the center region of the heat exchanger 1200.

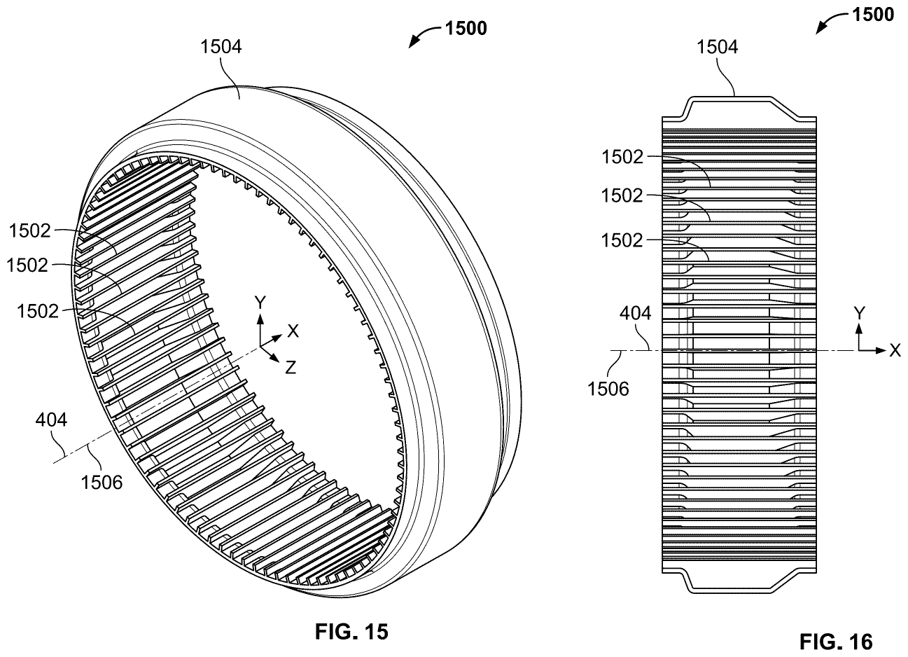

FIG. 15 is a perspective view of an example heat exchanger 1500 including a plurality of example axially oriented fins 1502. FIG. 16 is a cross-sectional view of the heat exchanger 1500 of FIG. 15 taken along the X-Y plane of FIG. 15. The heat exchanger 1500 of FIGS. 15 and 16 is generally an annular-shaped (e.g., ring-shaped) structure that is configured to be coupled to and circumscribed by a stator of an electric motor (e.g., the stator 400 of FIGS. 4 and 5).

In the illustrated example of FIGS. 15 and 16, the heat exchanger 1500 includes an example interface layer 1504 that forms an outer surface of the heat exchanger 1500. The interface layer 1504 can be of any thickness, and can be configured to have any number and/or type of segments, contours, bends, etc., including those shown in FIGS. 15 and 16. The interface layer 1504 of the heat exchanger 1500 is configured to be coupled to (e.g., thermally coupled to) the surrounding stator (e.g., the core 402 of the stator 400 of FIGS. 4 and 5). For example, the interface layer 1504 can be placed in direct physical contact with the core 402 of the surrounding stator 400 such that heat carried by the core 402 is efficiently transferred from the stator 400 to the heat exchanger 1500. In some examples, the radial extrusions 802 of FIG. 8 described above can extend to and/or otherwise contact the interface layer 1504 of the heat exchanger 1500. In other examples, the end plate 1002 of FIGS. 10 and 11 described above (which receives heat from the heat pipes 902 of FIG. 9 described above) can extend to and/or otherwise contact the interface layer 1504 of the heat exchanger 1500.

The interface layer 1504 of FIGS. 15 and 16 can be formed from any material that is suitable for transferring heat. For example, the interface layer 1504 can be formed from aluminum, steel, copper, brass, or some other highly conductive material. In some examples, the interface layer 1504 is formed from the same material as the fins 1502 of the heat exchanger 1500. For example, the fins 1502 and the interface layer 1504 of the heat exchanger 1500 can commonly be formed from aluminum. In other examples, the interface layer 1504 can instead be formed from a different material than the fins 1502 of the heat exchanger 1500. For example, the fins 1502 of the heat exchanger 1500 can be formed from aluminum, and the interface layer 1504 of the heat exchanger 1500 can be formed from copper, brass, or steel.

The heat exchanger 1500 of FIGS. 15 and 16 has an associated central axis 1506 (e.g., the X-axis as shown in FIGS. 15 and 16) that is coaxially located with the central axis 404 of the surrounding stator 400, with the central axis 1506 extending in an axial direction of the annular-shaped heat exchanger 1500. As shown in FIGS. 15 and 16, respective ones of the fins 1502 of the heat exchanger 1500 extend in a radially inward direction away from the interface layer 1504 of the heat exchanger 1500 and toward the central axis 1506 of the heat exchanger 1500. When the heat exchanger 1500 is coupled to the stator 400, the respective ones of the fins 1502 of the heat exchanger 1500 likewise extend in a radially inward direction away from the core 402 of the stator 400 and toward the central axis 404 of the stator 400.

Respective ones of the fins 1502 of FIGS. 15 and 16 are spaced apart from one another, with each one of the fins 1502 being axially oriented relative to the interface layer 1504 of the heat exchanger 1500. When the heat exchanger 1500 is coupled to the stator 400, each one of the fins 1502 of the heat exchanger 1500 is likewise axially oriented relative to the core 402 of the stator 400. When oriented axially as shown in FIGS. 15 and 16, each one of the fins 1502 (e.g., an inner edge of each fin 1502) of the heat exchanger 1500 is oriented parallel relative to the central axis 1506 of the heat exchanger 1500 and/or parallel relative to the central axis 404 of the stator 400.

In the illustrated example of FIGS. 15 and 16, the heat exchanger 1500 includes approximately ninety (90) axially oriented fins 1502. In other examples, the heat exchanger 1500 can instead include a greater number or a lesser number of axially oriented fins 1502 relative to the implementation shown in FIGS. 15 and 16. In some examples, one or more (e.g., in some cases all) of the fins 1502 of the heat exchanger 1500 are integrally formed with the interface layer 1504 of the heat exchanger 1500. In other examples, one or more (e.g., in some cases all) of the fins 1502 of the heat exchanger 1500 can be coupled to the interface layer 1504 of the heat exchanger 1500 via one or more fastener(s).

In the illustrated example of FIGS. 15 and 16, each one of the fins 1502 of the heat exchanger 1500 is spaced apart from the central axis 1506 of the heat exchanger 1500 and/or the central axis 404 of the stator 400 by a uniform distance. In other examples, one or more first one(s) of the fins 1502 of the heat exchanger 1500 can be spaced apart from the central axis 1506 of the heat exchanger 1500 and/or the central axis 404 of the stator 400 by a first distance, and one or more second one(s) of the fins 1502 of the heat exchanger 1500 can be spaced apart from the central axis 1506 of the heat exchanger 1500 and/or the central axis 404 of the stator 400 by a second distance that differs from (e.g., is greater than or less than) the first distance.

The heat exchanger 1500 of FIGS. 15 and 16 is particularly suitable for incorporation into and/or inclusion within outer rotor electric motor applications that experience a significant fluid mass flow rate in the axial direction through the center region of the heat exchanger 1500 and/or through the center region of the outer rotor electric motor that includes the heat exchanger 1500. Such applications include, for example, outer rotor electric motors used in aircraft, in wind turbines, or in other machines in which the prevailing direction of free stream fluid is parallel to the rotational axis of the electric motor. Under such conditions (e.g., significant axial fluid mass flow rate through center region) the axially oriented fin geometry associated with the heat exchanger 1500 of FIGS. 15 and 16 achieves a higher heat transfer coefficient than is achievable via the circumferentially oriented fin geometry associated with the heat exchanger 1200 of FIGS. 13 and 14 described above.

The axially oriented fin geometry associated with the heat exchanger 1500 of FIGS. 15 and 16 also provides manufacturing benefits relative to the circumferentially oriented fin geometry associated with the heat exchanger 1200 of FIGS. 12 and 13 described above. For example, the heat exchanger 1500 of FIGS. 15 and 16 can be designed as a single two dimensional (2D) axial extrusion, which suits conventional aluminum part manufacturing processes.

As another example, the fins 1502 of the heat exchanger 1500 of FIGS. 15 and 16 can advantageously be formed via sheet material folded and attached to the interface layer 1504 of the heat exchanger 1500. This process results in a fine continuous fin geometry that promotes a much higher surface area compared to that which can easily be manufactured from conventional single-part aluminum manufacturing processes. In such examples, the interface layer 1504 of the heat exchanger 1500 located between the fins 1502 of the heat exchanger 1500 on the one hand and the core 402 of the stator 400 on the other hand provides an even thermal interface between such structures. In some examples, the fins 1502 and interface layer 1504 can be formed from different materials (e.g., as discussed above) to improve the heat transfer coefficient to the ambient air.

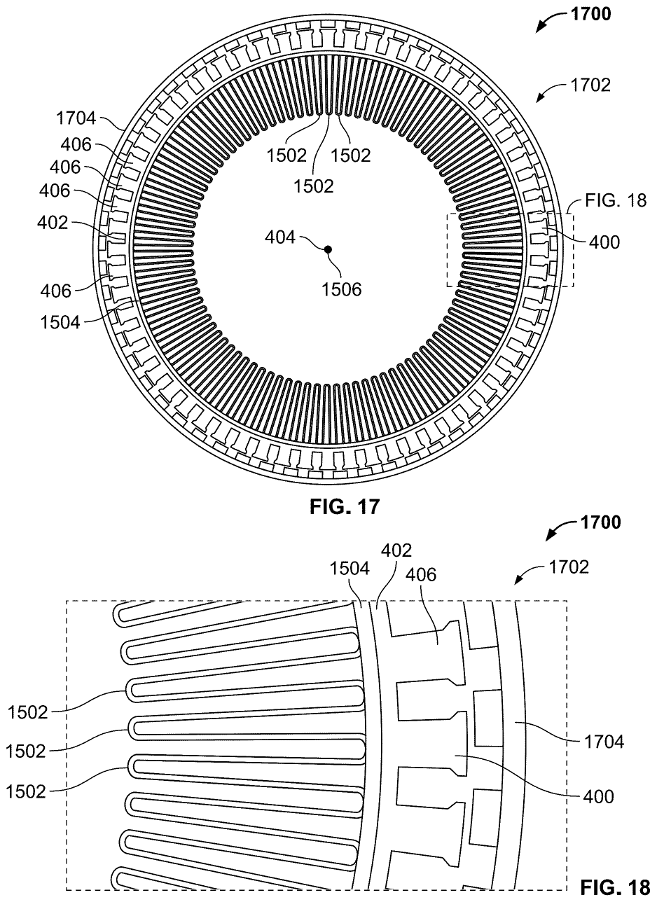

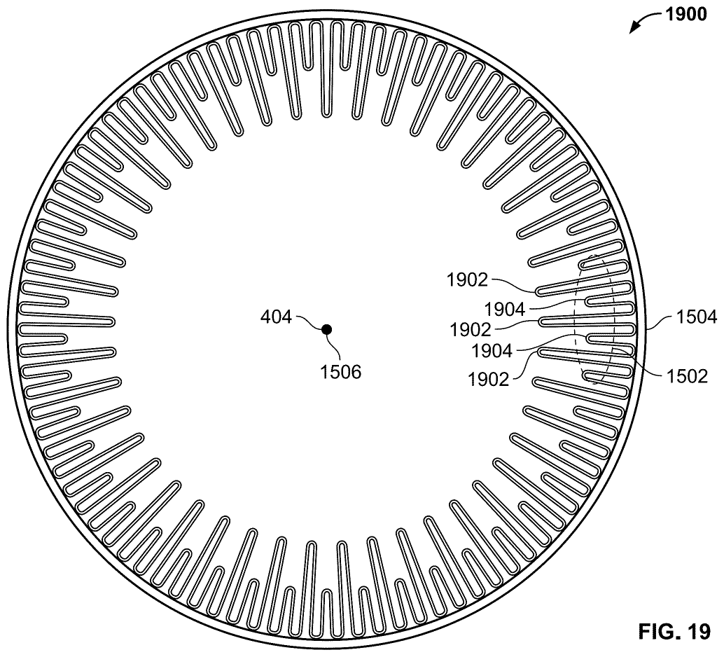

Forming the fins 1502 of the heat exchanger 1500 from folded sheet metal advantageously facilitates the formation of different types (e.g., uniform versus non-uniform) of fin patterns and/or fin configurations. For example, FIG. 17 is a cross-sectional view illustrating a first example fin configuration 1700 (e.g., a uniform fin configuration) for a heat exchanger including axially oriented fins. FIG. 18 is an enlarged view of a portion of FIG. 17. The fin configuration 1700 of FIGS. 17 and 18 can be implemented via the heat exchanger 1500 of FIGS. 15 and 16, including the fins 1502 and the interface layer 1504 thereof. As shown in FIGS. 17 and 18, each one of the fins 1502 of the heat exchanger 1500 extends in a radially inward direction from the interface layer 1504 of the heat exchanger 1500, with each one of the fins 1502 being spaced apart from the central axis 1506 of the heat exchanger 1500 and/or the central axis 404 of the stator 400 by a uniform distance. Stated differently, implementation of the fin configuration 1700 of FIGS. 17 and 18 results in each of the fins 1502 of the heat exchanger 1500 terminating at a common (e.g., uniform) distance away from the central axis 1506 of the heat exchanger 1500 and/or the central axis 404 of the stator 400. FIGS. 17 and 18 further illustrate the incorporation of the heat exchanger 1500 into an example electric motor 1702. As shown in FIGS. 17 and 18, the electric motor 1702 is an outer rotor electric motor that includes an example rotor 1704, the stator 400, and the heat exchanger 1500. As further shown in FIGS. 17 and 18, the rotor 1704 circumscribes the stator 400, and the stator 400 circumscribes the heat exchanger 1500.

As another example, FIG. 19 is a cross-sectional view illustrating a second example fin configuration 1900 (e.g., a non-uniform fin configuration) for a heat exchanger including axially oriented fins. The fin configuration 1900 of FIG. 19 can be implemented via the heat exchanger 1500 of FIGS. 15 and 16, including the fins 1502 and the interface layer 1504 thereof. As shown in FIG. 19, each one of the fins 1502 of the heat exchanger 1500 extends in a radially inward direction from the interface layer 1504 of the heat exchanger 1500. Example first ones 1902 of the fins 1502 are spaced apart from the central axis 1506 of the heat exchanger 1500 and/or the central axis 404 of the stator 400 by a first distance, and example second ones 1904 of the fins 1502 are spaced apart from the central axis 1506 of the heat exchanger 1500 and/or the central axis 404 of the stator 400 by a second distance different from (e.g., greater than) the first distance. Stated differently, implementation of the fin configuration 1900 of FIG. 19 results in the first ones 1902 of the fins 1502 of the heat exchanger 1500 terminating at a first distance away from the central axis 1506 of the heat exchanger 1500 and/or the central axis 404 of the stator 400, and the second ones 1904 of the fins 1502 of the heat exchanger 1500 terminating at a second distance away from the central axis 1506 of the heat exchanger 1500 and/or the central axis 404 of the stator 400, with the second distance differing from (e.g., being greater than) the first distance.

In comparison to the uniform fin configuration 1700 of FIGS. 17 and 18 described above, the non-uniform fin configuration 1900 of FIG. 19 facilitates a larger minimum fin spacing as respective ones of the fins 1502 approach the central axis 1506 of the heat exchanger 1500 and/or the central axis 404 of the stator 400. The larger minimum fin spacing associated with the non-uniform fin configuration 1900 is advantageous with regard to maintaining a desirable and uniform mass flow rate across all of the fins 1502 so as to maximize the heat transfer rate across the available volume.

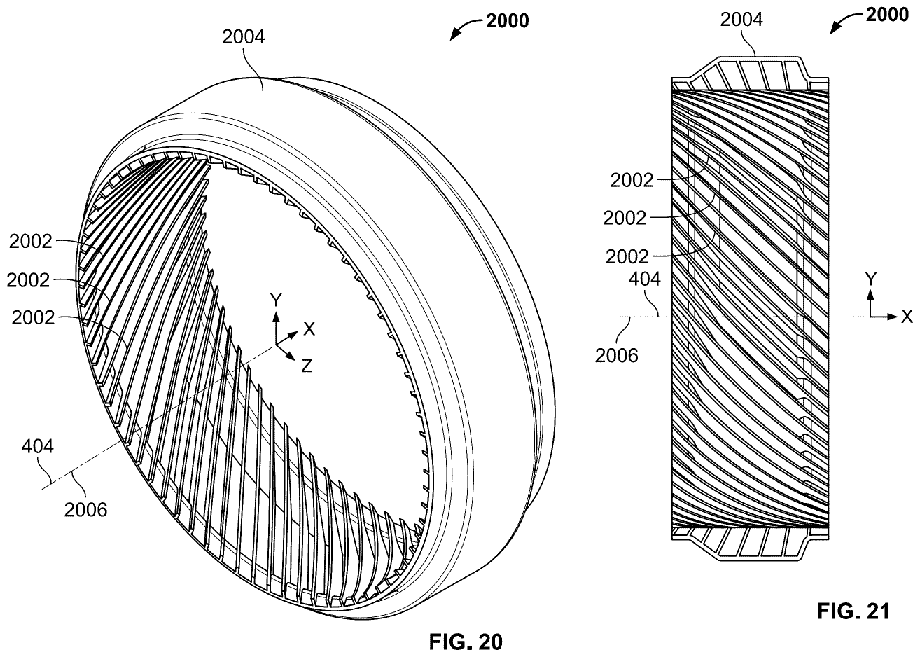

FIG. 20 is a perspective view of an example heat exchanger 2000 including a plurality of example helically oriented fins 2002. FIG. 21 is a cross-sectional view of the heat exchanger 2000 of FIG. 20 taken along the X-Y plane of FIG. 20. The heat exchanger 2000 of FIGS. 20 and 21 is generally an annular-shaped (e.g., ring-shaped) structure that is configured to be coupled to and circumscribed by a stator of an electric motor (e.g., the stator 400 of FIGS. 4 and 5).

In the illustrated example of FIGS. 20 and 21, the heat exchanger 2000 includes an example interface layer 2004 that forms an outer surface of the heat exchanger 2000. The interface layer 2004 can be of any thickness, and can be configured to have any number and/or type of segments, contours, bends, etc., including those shown in FIGS. 20 and 21. The interface layer 2004 of the heat exchanger 2000 is configured to be coupled to (e.g., thermally coupled to) the surrounding stator (e.g., the core 402 of the stator 400 of FIGS. 4 and 5). For example, the interface layer 2004 can be placed in direct physical contact with the core 402 of the surrounding stator 400 such that heat carried by the core 402 is efficiently transferred from the stator 400 to the heat exchanger 2000. In some examples, the radial extrusions 802 of FIG. 8 described above can extend to and/or otherwise contact the interface layer 2004 of the heat exchanger 2000. In other examples, the end plate 1002 of FIGS. 10 and 11 described above (which receives heat from the heat pipes 902 of FIG. 9 described above) can extend to and/or otherwise contact the interface layer 2004 of the heat exchanger 2000.

The interface layer 2004 of FIGS. 20 and 21 can be formed from any material that is suitable for transferring heat. For example, the interface layer 2004 can be formed from aluminum, steel, copper, brass, or some other highly conductive material. In some examples, the interface layer 2004 is formed from the same material as the fins 2002 of the heat exchanger 2000. For example, the fins 2002 and the interface layer 2004 of the heat exchanger 2000 can commonly be formed from aluminum. In other examples, the interface layer 2004 can instead be formed from a different material than the fins 2002 of the heat exchanger 2000. For example, the fins 2002 of the heat exchanger 2000 can be formed from aluminum, and the interface layer 2004 of the heat exchanger 2000 can be formed from copper, brass, or steel.

The heat exchanger 2000 of FIGS. 20 and 21 has an associated central axis 2006 (e.g., the X-axis as shown in FIGS. 20 and 21) that is coaxially located with the central axis 404 of the surrounding stator 400, with the central axis 2006 extending in an axial direction of the annular-shaped heat exchanger 2000. As shown in FIGS. 20 and 21, respective ones of the fins 2002 of the heat exchanger 2000 extend in a radially inward direction away from the interface layer 2004 of the heat exchanger 2000 and toward the central axis 2006 of the heat exchanger 2000. When the heat exchanger 2000 is coupled to the stator 400, the respective ones of the fins 2002 of the heat exchanger 2000 likewise extend in a radially inward direction away from the core 402 of the stator 400 and toward the central axis 404 of the stator 400.

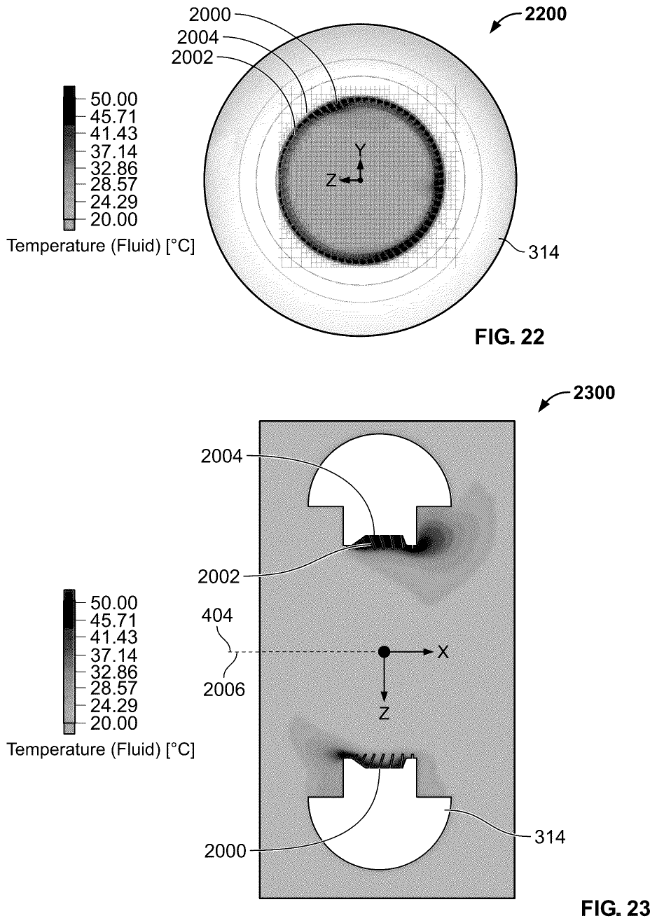

Respective ones of the fins 2002 of FIGS. 21 and 22 are spaced apart from one another, with each one of the fins 2002 being helically oriented relative to the interface layer 2004 of the heat exchanger 2000. When the heat exchanger 2000 is coupled to the stator 400, each one of the fins 2002 of the heat exchanger 2000 is likewise helically oriented relative to the core 402 of the stator 400. When oriented helically as shown in FIGS. 20 and 21, each one of the fins 2002 (e.g., an inner edge of each fin 2002) of the heat exchanger 2000 is oriented at a non-parallel, non-perpendicular angle relative to the central axis 2006 of the heat exchanger 2000 and/or at a non-parallel, non-perpendicular angle relative to the central axis 404 of the stator 400. In the illustrated example of FIGS. 20 and 21, each one of the fins 2002 (e.g., an inner edge of each fin 2002) is oriented at an angle of approximately forty-five degrees (45°) relative to the central axis 2006 of the heat exchanger 2000 and/or relative to the central axis 404 of the stator 400. In other examples, each one of the fins 2002 (e.g., an inner edge of each fin 2002) can instead be oriented at a greater angle (e.g., sixty degrees (60°), seventy-five degrees (75°), etc.) or at a lesser angle (e.g., thirty degrees (30°), fifteen degrees (15°), etc.) relative to the central axis 2006 of the heat exchanger 2000 and/or relative to the central axis 404 of the stator 400.

In the illustrated example of FIGS. 20 and 21, the heat exchanger 2000 includes approximately seventy (70) helically oriented fins 2002. In other examples, the heat exchanger 2000 can instead include a greater number or a lesser number of helically oriented fins 2002 relative to the implementation shown in FIGS. 20 and 21. In some examples, one or more (e.g., in some cases all) of the fins 2002 of the heat exchanger 2000 are integrally formed with the interface layer 2004 of the heat exchanger 2000. In other examples, one or more (e.g., in some cases all) of the fins 2002 of the heat exchanger 2000 can be coupled to the interface layer 2004 of the heat exchanger 2000 via one or more fastener(s).

In the illustrated example of FIGS. 20 and 21, each one of the fins 2002 of the heat exchanger 2000 is spaced apart from the central axis 2006 of the heat exchanger 2000 and/or the central axis 404 of the stator 400 by a uniform distance. In other examples, one or more first one(s) of the fins 2002 of the heat exchanger 2000 can be spaced apart from the central axis 2006 of the heat exchanger 2000 and/or the central axis 404 of the stator 400 by a first distance, and one or more second one(s) of the fins 2002 of the heat exchanger 2000 can be spaced apart from the central axis 2006 of the heat exchanger 2000 and/or the central axis 404 of the stator 400 by a second distance that differs from (e.g., is greater than or less than) the first distance.

Like the heat exchanger 1200 of FIGS. 12 and 13 described above, the heat exchanger 2000 of FIGS. 21 and 22 is particularly suitable for incorporation into and/or inclusion within an in-wheel outer rotor electric motor of an electric vehicle. For example, the heat exchanger 2000 can be implemented in connection with the in-wheel outer rotor electric motor 316 located in the rear wheel 314 of the electric motorcycle 300 of FIG. 3. In such an implementation, the rotor of the electric motor 316 circumscribes the stator of the electric motor 316, and the stator of the electric motor 316 circumscribes the heat exchanger 2000 of the electric motor 316, with the rotor being configured to rotate relative to the stator and relative to the heat exchanger 2000.

The helically oriented fin geometry associated with the heat exchanger 2000 of FIGS. 20 and 21 passively promotes axial airflow through the center region of an electric motor incorporating the heat exchanger 2000 when the heat exchanger 2000 and/or, more generally, the electric motor is/are presented with a longitudinal free stream of fluid. Relative to the circumferentially oriented fin geometry associated with the heat exchanger 1200 of FIGS. 12 and 13 described above, the helically oriented fin geometry associated with the heat exchanger 2000 of FIGS. 20 and 21 advantageously encourages a higher fluid mass flow rate when incorporated into a rear wheel of a motorcycle (e.g., the rear wheel 314 of the electric motorcycle 300 of FIG. 3).

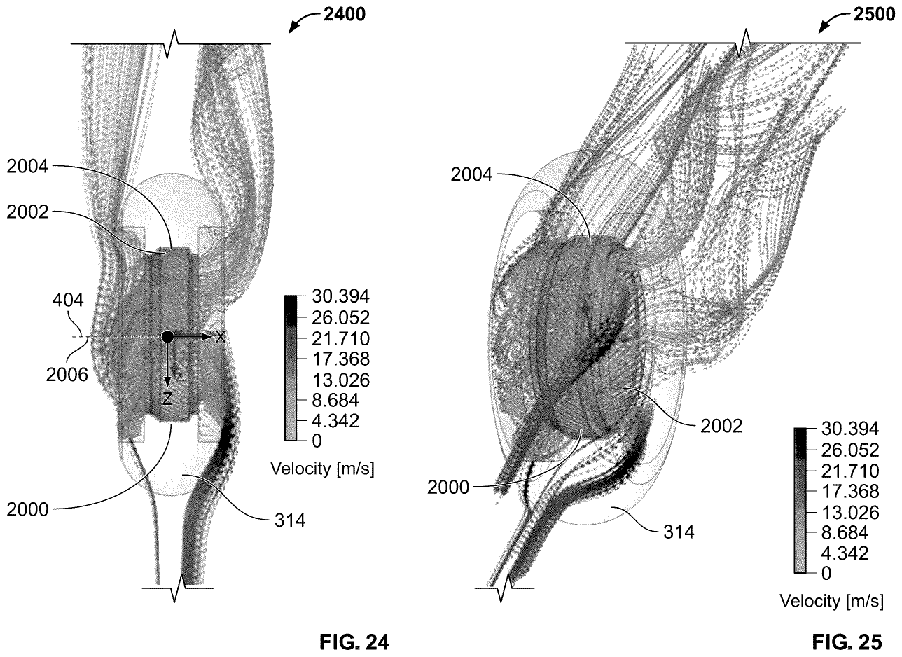

FIG. 22 is an example temperature distribution diagram 2200 for the heat exchanger 2000 of FIGS. 20 and 21. FIG. 23 is another example temperature distribution diagram 2300 for the heat exchanger 2000 of FIGS. 20 and 21. FIG. 24 is an example fluid motion diagram 2400 for the heat exchanger 2000 of FIGS. 20 and 21. FIG. 25 is another example fluid motion diagram 2500 for the heat exchanger 2000 of FIGS. 20 and 21. As shown in FIGS. 22-25, various analyses performed on the helically oriented fin geometry associated with the heat exchanger 2000 of FIGS. 20 and 21 demonstrate that the fluid passing over a rear wheel of a motorcycle (e.g., the rear wheel 314 of the electric motorcycle 300 of FIG. 3) having an in-wheel outer rotor electric motor (e.g., the electric motor 316 of the electric motorcycle 300 of FIG. 3) incorporating the heat exchanger 2000 of FIGS. 20 and 21 enters the heat exchanger 2000 on one side thereof and is biased to an exit on the other side thereof. Aside from improving the heat transfer coefficient of the heat exchanger 2000, this biasing effect can advantageously be used to manage the airflow relative to the electric motor and/or the rear wheel of the motorcycle. The management of such airflow can advantageously reduce the drag and the wake of the rear wheel of the motorcycle, which in turn can advantageously improve energy consumption as well as range of the motorcycle. Similar benefits can be achieved when incorporating the heat exchanger 2000 of FIGS. 21 and 22 into other in-wheel outer rotor electric motor applications for electric vehicles other than electric motorcycles.

While the helically oriented fin geometry associated with the heat exchanger 2000 of FIGS. 20 and 21 is particularly suitable for applications in which the heat exchanger 2000 and/or an electric motor incorporating the heat exchanger 2000 is/are presented with a longitudinal free stream of fluid (e.g., perpendicular to the central axis 2006 of the heat exchanger 2000), the helically oriented fin geometry can also be advantageous for applications in which a free stream of fluid is parallel to the central axis 2006 of the heat exchanger 2000. As discussed above in connection with the axially oriented fin geometry associated with the heat exchanger 1500 of FIGS. 15 and 16, such applications can include outer rotor electric motors used in aircraft, in wind turbines, or in other machines in which the prevailing direction of free stream fluid is parallel to the rotational axis of the electric motor. In comparison to the axially oriented fin geometry associated with the heat exchanger 1500 of FIGS. 15 and 16, the helically oriented fin geometry associated with the heat exchanger 2000 of FIGS. 20 and 21 advantageously provides a greater surface area to the fluid entering the heat exchanger 2000, but also generates a higher drag component. The performance comprise between these two competing factors can be managed based on the chosen inclination (e.g., the chosen helical angle) of the fins 2002 of the heat exchanger 2000 relative to the central axis 2006 of the heat exchanger 2000.

An outer rotor electric motor including any of the aforementioned heat exchangers and/or fin geometries (e.g., the circumferentially oriented fin geometry associated with the heat exchanger 1200 of FIGS. 12 and 13, the axially oriented fin geometry associated with the heat exchanger 1500 of FIGS. 15 and 16, the helically oriented fin geometry associated with the heat exchanger 2000 of FIGS. 20 and 21, etc.) can further include a disk that is coupled to and rotates along with the rotor of the electric motor, with the rotation of the disk causing an increase in the fluid velocity across the heat exchanger. Increasing the fluid velocity across the heat exchanger advantageously enhances the cooling capabilities of the electric motor, thereby enabling operation of the electric motor at higher power levels without the risk of overheating. The overall performance and reliability of the cooling system for the electric motor are accordingly improved. Reductions in fault probability and maintenance requirements are also achieved in this manner relative to known liquid-based cooling systems for electric motors. Implementation of the aforementioned disk is particularly advantageous for in-wheel outer rotor electric motors of electric vehicles (e.g., the electric motor 316 of the electric motorcycle 300 of FIG. 3).

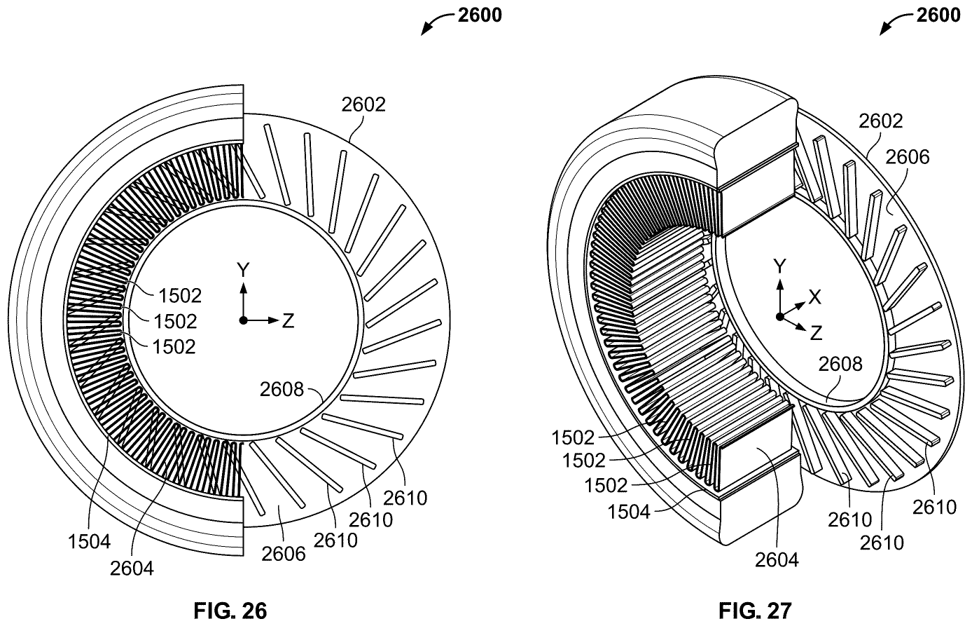

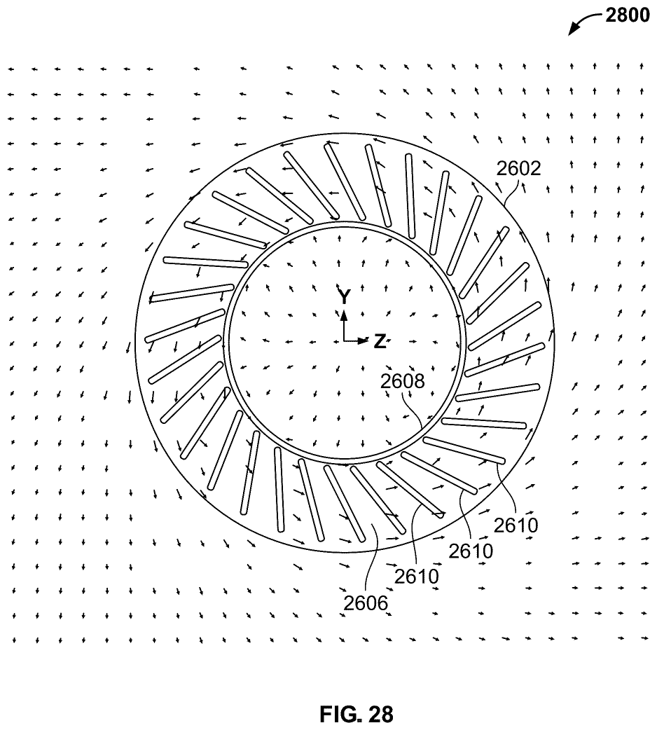

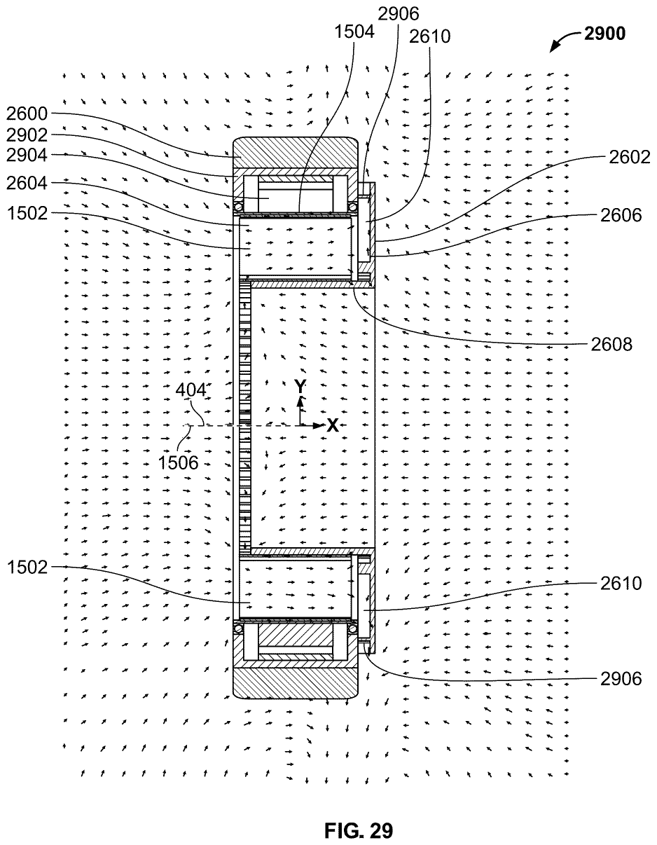

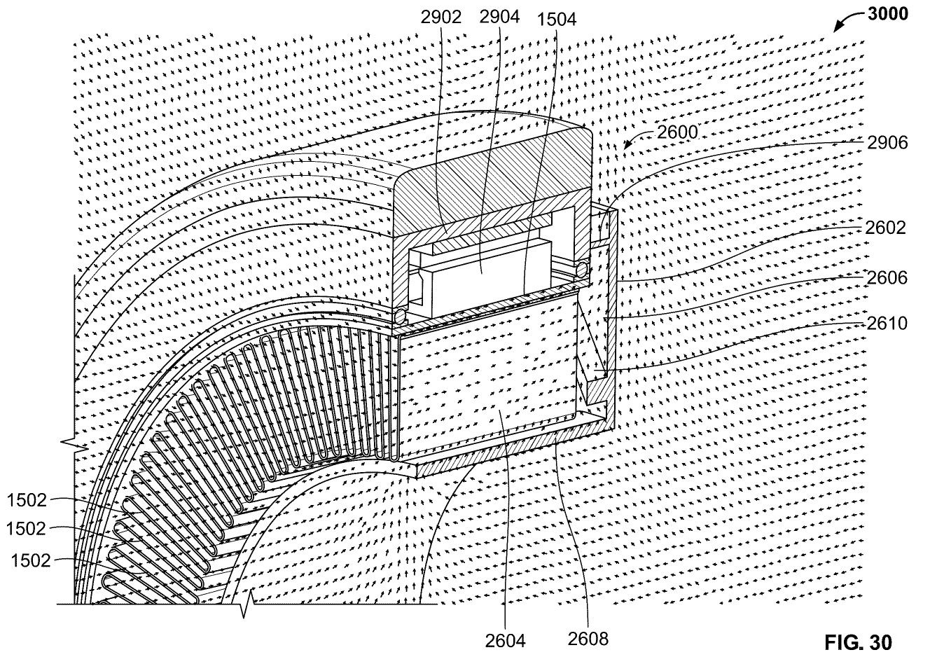

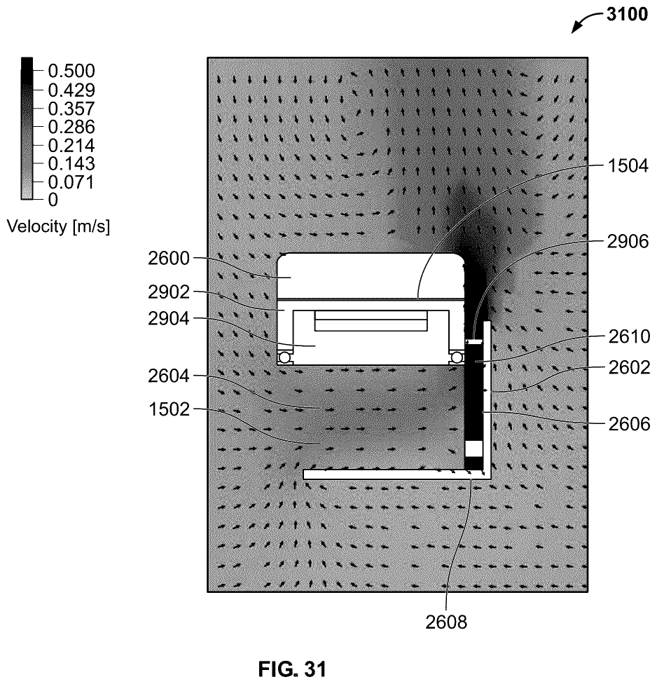

FIG. 26 is a side partial cutaway view of an example electric motor 2600 including an example disk 2602 configured to increase the fluid velocity across an example heat exchanger 2604 of the electric motor 2600. FIG. 27 is a perspective partial cutaway view of the electric motor 2600 of FIG. 26. FIG. 28 is an example fluid motion diagram 2800 for the disk 2602 of the electric motor 2600 of FIGS. 26 and 27. FIG. 29 is another example fluid motion diagram 2900 for the electric motor 2600 of FIGS. 26-28. FIG. 30 is another example fluid motion diagram 3000 for the electric motor 2600 of FIGS. 26-29. FIG. 31 is another example fluid motion diagram 3100 for the electric motor 2600 of FIGS. 26-30.

The electric motor 2600 of FIGS. 26-31 includes the disk 2602, the heat exchanger 2604, an example rotor 2902, and an example stator 2904. The rotor 2902 of the electric motor 2600 circumscribes the stator 2904 of the electric motor 2600, with the rotor 2902 being configured to rotate relative to the stator 2904. The stator 2904 of the electric motor 2600 circumscribes the heat exchanger 2604 of the electric motor 2600. In some examples, the stator 2904 of FIGS. 26-31 is implemented by and/or as the stator 400 of FIGS. 4 and 5, including the core 402 and the teeth 406 thereof. In some examples, the stator 2904 of FIGS. 26-31 further includes windings implemented by and or as the edgewise coils 600 of FIGS. 6 and 7.

In the illustrated example of FIGS. 26-31, the heat exchanger 2604 of the electric motor 2600 is implemented by and/or as the heat exchanger 1500 of FIGS. 15 and 16, including the axially oriented fins 1502 and the interface layer 1504 thereof. In other examples, the heat exchanger 2604 of FIGS. 26-31 can instead be implemented by and/or as the heat exchanger 1200 of FIGS. 12 and 13, including the circumferentially oriented fins 1202 and the interface layer 1204 thereof. In still other examples, the heat exchanger 2604 of FIGS. 26-31 can instead be implemented by and/or as the heat exchanger 2000 of FIGS. 20 and 21, including the helically oriented fins 2002 and the interface layer 2004 thereof.

The disk 2602 of the electric motor 2600 of FIGS. 26-31 is coupled to the rotor 2902 of the electric motor 2600 such that the disk 2602 rotates along with (e.g., in unison with) the rotor 2902 relative to the stator 2904 of the electric motor 2600. In the illustrated example of FIGS. 26-31, the disk 2602 includes an example inner surface 2606, a plurality of example flanges 2906, an example lip 2608, and a plurality of example blades 2610. The inner surface 2606 of the disk 2602 is spaced apart from and located along a side (e.g., a right side or a left side) of the electric motor 2600, with the inner surface 2606 being configured to cover at least a portion of a corresponding side of the stator 2904 (e.g., a side portion of the stator 2904) and at least a portion of a corresponding side of the heat exchanger 2604 (e.g., a side portion of the heat exchanger 2604). For example, as shown in FIGS. 26-31, the inner surface 2606 of the disk 2602 covers (e.g., spans across) the core 402 and at least a portion of the teeth 406 of the stator 2904 along the side of the stator 2904, and further covers (e.g., spans across) the fins 1502 and the interface layer 1504 of the heat exchanger 2604 along the side of the heat exchanger 2604.

The flanges 2906 of the disk 2602 of FIGS. 26-31 couple the disk 2602 to the rotor 2902 of the electric motor 2600. Respective ones of the flanges 2906 are spaced apart from one another about the circumference of the disk 2602, with each one of the flanges 2906 extending between the inner surface 2606 of the disk 2602 and an outer side surface of the rotor 2902 of the electric motor 2600. In the illustrated example of FIGS. 26-31, the flanges 2906 of the disk 2602 are located radially outward relative to the blades 2610 of the disk 2602. In some examples, one or more (e.g., in some cases all) of the flanges 2906 of the disk 2602 are integrally formed with the inner surface 2606 of the disk 2602. In other examples, one or more (e.g., in some cases all) of the flanges 2906 of the disk 2602 can be coupled to the inner surface 2606 of the disk 2602 via one or more fastener(s). The flanges 2906 of the disk 2602 can be of any size, shape, number, and/or configuration suitable to form one or more connection(s) that couple(s) the disk 2602 to the rotor 2902 of the electric motor 2600 in a manner that causes the disk 2602 to rotate along with (e.g., in unison with) the rotor 2902 as the rotor 2902 rotates relative to the stator 2904 or the electric motor 2600.

The lip 2608 of the disk 2602 of FIGS. 26-31 extends from the inner surface 2606 of the disk 2602 in an axially inward direction (e.g., perpendicular to the inner surface 2606 of the disk 2602 and/or parallel to the central axis 1506 of the heat exchanger 2604). In the illustrated example of FIGS. 26-31, the lip 2608 of the disk 2602 is located radially inward relative to the blades 2610 of the disk 2602. In some examples, the lip 2608 of the disk 2602 is integrally formed with the inner surface 2606 of the disk 2602. In other examples, the lip 2608 of the disk 2602 can be coupled to the inner surface 2606 of the disk 2602 via one or more fastener(s). The lip 2608 of the disk 2602 can be of any size, shape, and/or configuration suitable to guide and/or direct a fluid flow that passes through the fins 1502 of the heat exchanger 2604 to and/or toward the blades 2610 of the disk 2602.

The blades 2610 of the disk 2602 of FIGS. 26-31 extend from the inner surface 2606 of the disk 2602 in an axially inward direction (e.g., perpendicular to the inner surface 2606 of the disk 2602 and/or parallel to the central axis 1506 of the heat exchanger 2604). Respective ones of the blades 2610 are spaced apart from one another about the circumference of the disk 2602, with each one of the blades 2610 having an angled radial orientation relative to the disk 2602. In the illustrated example of FIGS. 26-31, the disk 2602 includes approximately thirty (30) blades 2610. In other examples, the disk 2602 can instead include a greater number or a lesser number of blades 2610 relative to the implementation shown in FIGS. 26-31. In some examples, one or more (e.g., in some cases all) of the blades 2610 of the disk 2602 are integrally formed with the inner surface 2606 of the disk 2602. In other examples, one or more (e.g., in some cases all) of the blades 2610 of the disk 2602 can be coupled to the inner surface 2606 of the disk 2602 via one or more fastener(s).

In the illustrated example of FIGS. 26-31, the blades 2610 cause the disk 2602 to function as a centrifugal fan that radially expels air from the electric motor 2600, which in turn causes an increase in the air velocity within the heat exchanger 2604. As the disk 2602 rotates (e.g., based on rotation of the rotor 2902 of the electric motor 2600), the blades 2610 of the disk 2602 impart centrifugal forces on the fluid flow that is received at the disk 2602 (e.g., from the fins 1502 of the heat exchanger 2604), thereby causing the fluid flow to be forcefully expelled from the electric motor 2600 in a radially outward direction. The aforementioned centrifugal airflow effect that is generated via the blades 2610 in response to the rotation of the disk 2602 is best shown in the fluid motion diagram 2800 of FIG. 28, and can also be observed in the fluid motion diagram 2900 of FIG. 29, the fluid motion diagram 3000 of FIG. 30, and/or the fluid motion diagram 3100 of FIG. 31, which illustrate air being drawn in from the left of the electric motor 2600, through the fins 1502 of the heat exchanger 2604, and then radially outward via the blades 2610 of the disk 2602.

As a direct result of the aforementioned centrifugal airflow effect caused by the blades 2610 of the disk 2602, the fluid velocity associated with the airflow traveling across the fins 1502 of the heat exchanger 2604 increases. Increasing the fluid velocity across the fins 1502 of the heat exchanger 2604 advantageously increases the heat transfer rate of the heat exchanger 2604 as well as the overall performance of the electric motor 2600. Higher rotational speeds of the rotor 2902 of the electric motor 2600 cause corresponding higher rotational speeds of the disk 2602, which in turn produce larger increases in the fluid velocity across the fins 1502 of the heat exchanger 2604. The fluid velocity through the heat exchanger 2604 and/or, more generally, through the electric motor 2600 is accordingly linked with the wheel speed of an electric vehicle that incorporates the electric motor 2600 of FIGS. 26-31. The cooling performance of the system is therefore also linked with the wheel speed of the electric vehicle. This relationship is advantageous as the losses (e.g., aerodynamic drag from the vehicle body) associated with the electric motor 2600 are also linked with the wheel speed of the electric vehicle.

The following paragraphs provide various examples in relation to the disclosed cooling assemblies for outer rotor electric motors.

Example 1 includes an electric motor. In Example 1, the electric motor includes a stator, a rotor, and a heat exchanger. The stator has a central axis. The rotor circumscribes the stator. The rotor is configured to rotate relative to the stator. The heat exchanger is coupled to the stator. The stator circumscribes the heat exchanger. The heat exchanger includes a plurality of fins extending in a radially inward direction away from the stator and toward the central axis.

Example 2 includes the electric motor of Example 1. In Example 2, respective ones of the plurality of fins are circumferentially oriented.

Example 3 includes the electric motor of Example 1. In Example 3, respective ones of the plurality of fins are axially oriented.

Example 4 includes the electric motor of Example 1. In Example 4, respective ones of the plurality of fins are helically oriented.

Example 5 includes the electric motor of Example 1. In Example 5, respective ones of the plurality of fins are spaced apart from the central axis by a uniform distance.

Example 6 includes the electric motor of Example 1. In Example 6, the plurality of fins includes first respective ones of the plurality of fins spaced apart from the central axis by a first distance and second respective ones of the plurality of fins spaced apart from the central axis by a second distance different from the first distance.

Example 7 includes the electric motor of Example 1. In Example 7, the electric motor further includes a disk coupled to the rotor. The disk is configured to rotate with the rotor as the rotor rotates relative to the stator. The disk includes an inner surface that covers a side portion of the stator and a side portion of the heat exchanger. The disk further includes a plurality of blades extending in an axially inward direction away from the inner surface and toward the heat exchanger.

Example 8 includes the electric motor of Example 1. In Example 8, the heat exchanger further includes an interface layer located between the stator and the plurality of fins.

Example 9 includes the electric motor of Example 8. In Example 9, the plurality of fins and the interface layer are formed from the same material.

Example 10 includes the electric motor of Example 8. In Example 10, the plurality of fins and the interface layer are formed from different materials.

Example 11 includes the electric motor of Example 1. In Example 11, the stator includes a core. The stator further includes a plurality of teeth extending in a radially outward direction away from the core. Respective ones of the plurality of teeth are spaced apart from one another by respective ones of a plurality of slots. The stator further includes a plurality of edgewise coils. Respective ones of the plurality of edgewise coils are radially loaded onto corresponding respective ones of the plurality of the teeth.

Example 12 includes the electric motor of Example 11. In Example 12, the electric motor further includes a plurality of extrusions extending radially between the heat exchanger and the respective ones of the plurality of edgewise coils such that the respective ones of the plurality of edgewise coils are directly thermally coupled to the heat exchanger via respective ones of the plurality of extrusions.

Example 13 includes the electric motor of Example 11. In Example 13, the electric motor further includes a plurality of heat pipes extending axially between the respective ones of the plurality of edgewise coils. The heat exchanger further includes an end plate extending radially between an interface layer of the heat exchanger and the respective ones of the plurality of heat pipes such that the respective ones of the plurality of edgewise coils are directly thermally coupled to the interface layer of the heat exchanger via the end plate and the respective ones of the plurality of heat pipes.

Example 14 includes an in-wheel electric motor. In Example 14, the in-wheel electric motor includes a stator. The stator includes a core having a central axis. The stator further includes a plurality of teeth extending in a radially outward direction away from the core. Respective ones of the plurality of teeth are spaced apart from one another by respective ones of a plurality of slots. The stator further includes a plurality of edgewise coils. Respective ones of the plurality of edgewise coils are radially loaded onto corresponding respective ones of the plurality of the teeth. The in-wheel electric motor further includes a rotor. The rotor circumscribes the stator. The rotor is configured to rotate relative to the stator. The in-wheel electric motor further includes a heat exchanger. The heat exchanger is coupled to the stator. The stator circumscribes the heat exchanger. The heat exchanger includes a plurality of fins extending in a radially inward direction away from the stator and toward the central axis. The heat exchanger further includes an interface layer located between the core of the stator and the plurality of fins of the heat exchanger.

Example 15 includes the in-wheel electric motor of Example 14. In Example 15, respective ones of the plurality of fins are circumferentially oriented.

Example 16 includes the in-wheel electric motor of Example 14. In Example 16, respective ones of the plurality of fins are axially oriented.

Example 17 includes the in-wheel electric motor of Example 14. In Example 17, respective ones of the plurality of fins are helically oriented.

Example 18 includes the in-wheel electric motor of Example 14. In Example 18, the in-wheel electric motor further in includes a disk coupled to the rotor. The disk is configured to rotate with the rotor as the rotor rotates relative to the stator. The disk includes an inner surface that covers a side portion of the stator and a side portion of the heat exchanger. The disk further includes a plurality of blades extending in an axially inward direction away from the inner surface and toward the heat exchanger.

Example 19 includes the in-wheel electric motor of Example 14. In Example 19, the in-wheel electric motor further includes a plurality of extrusions extending radially between the heat exchanger and the respective ones of the plurality of edgewise coils such that the respective ones of the plurality of edgewise coils are directly thermally coupled to the heat exchanger via respective ones of the plurality of extrusions.

Example 20 includes the in-wheel electric motor of Example 14. In Example 20, the in-wheel electric motor further includes a plurality of heat pipes extending axially between the respective ones of the plurality of edgewise coils. The heat exchanger further includes an end plate extending radially between the interface layer of the heat exchanger and the respective ones of the plurality of heat pipes such that the respective ones of the plurality of edgewise coils are directly thermally coupled to the interface layer of the heat exchanger via the end plate and the respective ones of the plurality of heat pipes.

Although certain example apparatus, systems, methods, and articles of manufacture have been disclosed herein, the scope of coverage of this patent is not limited thereto. On the contrary, this patent covers all apparatus, systems, methods, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An electric motor, comprising:
a stator having a central axis;
a rotor circumscribing the stator, the rotor configured to rotate relative to the stator; and
a heat exchanger coupled to the stator, the stator circumscribing the heat exchanger, the heat exchanger including a plurality of fins extending in a radially inward direction away from the stator and toward the central axis.

2. The electric motor of claim 1, wherein respective ones of the plurality of fins are circumferentially oriented.

3. The electric motor of claim 1, wherein respective ones of the plurality of fins are axially oriented.

4. The electric motor of claim 1, wherein respective ones of the plurality of fins are helically oriented.

5. The electric motor of claim 1, wherein respective ones of the plurality of fins are spaced apart from the central axis by a uniform distance.

6. The electric motor of claim 1, wherein the plurality of fins includes first respective ones of the plurality of fins spaced apart from the central axis by a first distance and second respective ones of the plurality of fins spaced apart from the central axis by a second distance different from the first distance.

7. The electric motor of claim 1, further comprising a disk coupled to the rotor, the disk configured to rotate with the rotor as the rotor rotates relative to the stator, the disk including an inner surface that covers a side portion of the stator and a side portion of the heat exchanger, the disk further including a plurality of blades extending in an axially inward direction away from the inner surface and toward the heat exchanger.

8. The electric motor of claim 1, wherein the heat exchanger further includes an interface layer located between the stator and the plurality of fins.

9. The electric motor of claim 8, wherein the plurality of fins and the interface layer are formed from the same material.

10. The electric motor of claim 8, wherein the plurality of fins and the interface layer are formed from different materials.

11. The electric motor of claim 1, wherein the stator includes:
a core;
a plurality of teeth extending in a radially outward direction away from the core, respective ones of the plurality of teeth being spaced apart from one another by respective ones of a plurality of slots; and
a plurality of edgewise coils, respective ones of the plurality of edgewise coils being radially loaded onto corresponding respective ones of the plurality of the teeth.

12. The electric motor of claim 11, further comprising a plurality of extrusions extending radially between the heat exchanger and the respective ones of the plurality of edgewise coils such that the respective ones of the plurality of edgewise coils are directly thermally coupled to the heat exchanger via respective ones of the plurality of extrusions.

13. The electric motor of claim 11, further comprising a plurality of heat pipes extending axially between the respective ones of the plurality of edgewise coils, wherein the heat exchanger further includes an end plate extending radially between an interface layer of the heat exchanger and the respective ones of the plurality of heat pipes such that the respective ones of the plurality of edgewise coils are directly thermally coupled to the interface layer of the heat exchanger via the end plate and the respective ones of the plurality of heat pipes.

14. An in-wheel electric motor, comprising:
a stator including:
a core having a central axis;
a plurality of teeth extending in a radially outward direction away from the core, respective ones of the plurality of teeth being spaced apart from one another by respective ones of a plurality of slots; and
a plurality of edgewise coils, respective ones of the plurality of edgewise coils being radially loaded onto corresponding respective ones of the plurality of the teeth;
a rotor circumscribing the stator, the rotor configured to rotate relative to the stator; and
a heat exchanger coupled to the stator, the stator circumscribing the heat exchanger, the heat exchanger including a plurality of fins extending in a radially inward direction away from the stator and toward the central axis, the heat exchanger further including an interface layer located between the core of the stator and the plurality of fins of the heat exchanger.

15. The in-wheel electric motor of claim 14, wherein respective ones of the plurality of fins are circumferentially oriented.

16. The in-wheel electric motor of claim 14, wherein respective ones of the plurality of fins are axially oriented.

17. The in-wheel electric motor of claim 14, wherein respective ones of the plurality of fins are helically oriented.

18. The in-wheel electric motor of claim 14, further comprising a disk coupled to the rotor, the disk configured to rotate with the rotor as the rotor rotates relative to the stator, the disk including an inner surface that covers a side portion of the stator and a side portion of the heat exchanger, the disk further including a plurality of blades extending in an axially inward direction away from the inner surface and toward the heat exchanger.

19. The in-wheel electric motor of claim 14, further comprising a plurality of extrusions extending radially between the heat exchanger and the respective ones of the plurality of edgewise coils such that the respective ones of the plurality of edgewise coils are directly thermally coupled to the heat exchanger via respective ones of the plurality of extrusions.

20. The in-wheel electric motor of claim 14, further comprising a plurality of heat pipes extending axially between the respective ones of the plurality of edgewise coils, wherein the heat exchanger further includes an end plate extending radially between the interface layer of the heat exchanger and the respective ones of the plurality of heat pipes such that the respective ones of the plurality of edgewise coils are directly thermally coupled to the interface layer of the heat exchanger via the end plate and the respective ones of the plurality of heat pipes.
